(19) United States
(12) Patent Application Publication
(10) Pub. No.: US 2023/0217374 A1
(43) Pub. Date: Jul. 6, 2023

(54) METHOD OF PERFORMING POWER CONTROL WHEN PUCCH REPETITION TRANSMISSION IS APPLIED THROUGH MULTIPLE TRANSMISSION AND RECEPTION POINTS IN NEXT-GENERATION WIRELESS COMMUNICATION SYSTEM

(71) Applicant: SAMSUNG ELECTRONICS CO., LTD., Suwon-si (KR)

(72) Inventors: Seungri JIN, Suwon-si (KR); Anil AGIWAL, Suwon-si (KR)

(21) Appl. No.: 18/149,559

(22) Filed: Jan. 3, 2023

(30) Foreign Application Priority Data
Jan. 3, 2022 (KR) 10-2022-0000520

(51) Int. Cl. H04W 52/14; H04W 52/08; H04W 52/24

(52) U.S. Cl. CPC H04W 52/146; H04W 52/08; H04W 52/242

(57) ABSTRACT

The present disclosure relates to a 5G generation or pre-5G communication system for supporting a higher data transmission rate beyond a 4G generation communication system such as LTE. According to various embodiments of the present disclosure, a method performed by a UE in a wireless communication system, the method comprising, receiving, from a base station, an RRC message including information on at least one power control set for repetition of a PUCCH transmission based on a single beam configuration, and information on one or more PUCCH resource, receiving, from the base station, a MAC CE indicating ID of the one or more PUCCH resource associated with ID of the at least one power control set; and updating the information on the at least one power control set corresponding to at least one TRP, based on the received MAC CE.

### CROSS-REFERENCE TO RELATED APPLICATIONS

This application is based on and claims priority under 35 U.S.C. § 119 to Korean Patent Application No. 10-2022-0000520 filed Jan. 3, 2022, in the Korean Intellectual Property Office, the disclosure of which is incorporated by reference herein in its entirety.

### BACKGROUND

### 1. Field

The disclosure relates to a method and apparatus for performing power control when a physical uplink control channel (PUCCH) repetition transmission is applied through multiple transmission and reception points in a next-generation wireless communication system.

### 2. Description of Related Art

To satisfy a wireless data traffic demand which is growing after a 4th generation (4G) communication system is commercialized, efforts are exerted to develop an advanced 5th generation (5G) communication system or a pre-5G communication system. For this reason, the 5G communication system or the pre-5G communication system is referred to as a beyond 4G network communication system or a post long term evolution (LTE) system.

To achieve a high data rate, the 5G communication system considers its realization in an extremely high frequency. To mitigate a path loss of propagation and to extend a propagation distance in a frequency range (FR) 1 bandwidth high frequency near 6 GHz and the extremely high frequency band over 6 GHz, the 5G communication system is discussing beamforming, massive multiple-input multiple-output (MIMO), full dimensional (FD)-MIMO, array antenna, analog beam-forming, and large scale antenna techniques.

Also, for network enhancement of the system, the 5G communication system is developing techniques such as evolved small cell, advanced small cell, cloud radio access network (RAN), ultra-dense network, device to device (D2D) communication, wireless backhaul, moving network, cooperative communication, coordinated multi-points (CoMP), and receive interference cancellation.

Besides, the 5G system is developing hybrid frequency shift keying and quadrature amplitude modulation (FQAM) and sliding window superposition coding (SWSC) as advanced coding modulation (ACM) schemes, and filter bank multi carrier (FBMC), non-orthogonal multiple access (NOMA), and sparse code multiple access (SCMA) as advanced access technologies.

Meanwhile, Internet is evolving from a human-centered connection network in which humans create and consume information, to an Internet of things (IoT) network which exchanges and processes information between distributed components such as objects. Internet of everything (IoE) technology which combines IoT technology with big data processing technology through connection with a cloud server is also emerging. To implement the IoT, technology elements such as sensing technology, wired and wireless communication and network infrastructure, service interface technology, and security technology are required, and techniques such as a sensor network for connection between objects, machine to machine (M2M), and machine type communication (MTC) are recently studied. The IoT environment may be applied to fields such as a smart home, a smart building, a smart city, a smart car or a connected car, a smart grid, health care, smart home appliances, and advanced medical services through convergence and composition between intelligent internet technology (IT) technology which creates new values in human life by collecting and analyzing data generated from the connected objects and various industries.

Hence, various attempts for applying the 5G communication system to the IoT network are being made. For example, the technologies such as sensor network, M2M, and MTC are implemented by schemes such as beamforming, multiple input multiple output (MIMO), and array antenna which are the 5G communication technologies. Applying a cloud radio access network (RAN) as the big data processing technology as aforementioned may be said to be an example of the convergence of the 5G technology and the IoT technology.

Since the development of the wireless communication system makes it possible to provide various services as described above, there is a need for a method for effectively providing the services.

### SUMMARY

The disclosure provides a method and apparatus for performing power control when a physical uplink control channel (PUCCH) repetition transmission is applied through multiple transmission and reception points in a next-generation wireless communication system.

An operation of a user equipment (UE) of a mobile communication system according to an embodiment of the disclosure may include receiving from a base station a message including information on multiple transmission reception points (TRPs), configuration information for physical uplink control channel (PUCCH) repetition transmission through the multiple TRPs, and PUCCH power control configuration information in a frequency range 1 (FR1) band, configuring an initial PUCCH power parameter, based on the message, receiving a medium access control (MAC) control element (CE) for PUCCH power control, and updating the PUCCH power parameter, based on the received MAC CE.

According to an embodiment of the disclosure, it is possible to instruct to control transmit power, which is to be applied to a physical uplink control channel (PUCCH) resource transmission, for each transmission and reception point (TRP) in a mobile communication system. Therefore, when PUCCH repetition transmission is configured through multiple TRPs, a user equipment (UE) may be instructed to control power for each TRP and may perform PUCCH transmission depending on a channel condition.

Before undertaking the DETAILED DESCRIPTION below, it may be advantageous to set forth definitions of certain words and phrases used throughout this patent document: the terms “include” and “comprise.” as well as derivatives thereof, mean inclusion without limitation, the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a long term evolution (LTE) system according to an embodiment of the present disclosure;

FIG. 2 illustrates a radio protocol structure in an LTE system according to an embodiment of the present disclosure:

FIG. 3 illustrates a structure of a next-generation mobile communication system according to an embodiment of the present disclosure;

FIG. 4 illustrates a radio protocol structure of a next-generation mobile communication system according to an embodiment of the present disclosure;

FIG. 5 illustrates a structure of another next-generation mobile communication system according to an embodiment of the present disclosure;

FIG. 6 illustrates a structure of a next-generation mobile communication system and a scenario of applying a PUCCH resource configuration and beam activation operation according to an embodiment of the present disclosure:

FIG. 7 illustrates a structure of a next-generation mobile communication system and a scenario of applying a PUCCH resource configuration and beam activation operation according to an embodiment of the present disclosure:

FIG. 8 illustrates an operation of updating transmission beams simultaneously by individually controlling and grouping multiple PUCCH resources configured through multiple serving cells and BWPs in an NR system according to an embodiment of the present disclosure;

FIG. 9 illustrates an operation of configuring and updating power control for PUCCH resource transmission when PUCCH repetition transmission is configured in multiple TRPs in an NR FR1 system according to an embodiment of the present disclosure;

FIG. 10 illustrates a MAC CE structure for a UE operation in which a PUCCH resource power control parameter for each TRP is configured with an RRC control message and an update is applied through a MAC CE when a PUCCH repetition transmission in FR1 is configured through multiple TRPs according to an embodiment of the present disclosure;

FIG. 11 illustrates a MAC CE structure for a UE operation in which a PUCCH resource power control parameter for each TRP is configured with an RRC control message and an update is applied through a MAC CE when a PUCCH repetition transmission in FR1 is configured through multiple TRPs according to an embodiment of the present disclosure;

FIG. 12 illustrates a MAC CE structure for a UE operation in which a PUCCH resource power control parameter for each TRP is configured with an RRC control message and an update is applied through a MAC CE, when a PUCCH repetition transmission in FR1 is configured through multiple TRPs according to another embodiment of the present disclosure;

FIG. 13 illustrates a MAC CE structure for a UE operation in which a PUCCH resource power control parameter for each TRP is configured with an RRC control message and an update is applied through a MAC CE when a PUCCH repetition transmission in FR1 is configured through multiple TRPs according to another embodiment of the present disclosure,

FIG. 14 illustrates an operation of a UE according to an embodiment of the present disclosure;

FIG. 15 illustrates an operation of a base station according to an embodiment of the present disclosure;

FIG. 16 illustrates a structure of a UE according to an embodiment of the present disclosure; and

FIG. 17 illustrates a structure of a base station according to an embodiment of the present disclosure.

### DETAILED DESCRIPTION

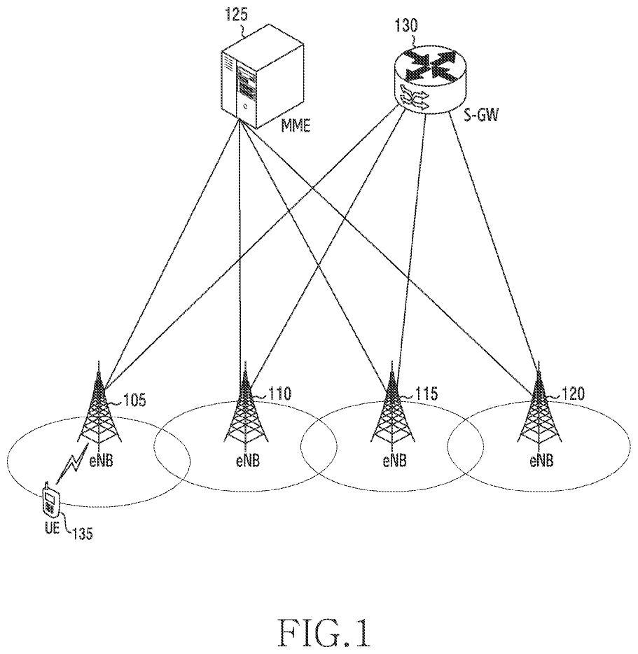

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, an embodiment of the disclosure is described in detail with reference to the accompanying drawings. In the describing of the embodiment, descriptions which are well known in the technical field to which the disclosure belongs and are not related directly to the disclosure will be omitted. This is to convey the disclosure more clearly by omitting unnecessary description.

For the same reason, some components may be exaggerated, omitted, or schematically illustrated in the accompanying drawings. Also, a size of each component does not completely reflect an actual size. In the drawings, like reference numerals denote like or corresponding components.

Advantages and features of the disclosure and methods of accomplishing the same may be understood more clearly by reference to the following detailed description of the embodiments and the accompanying drawings. However, the disclosure is not limited to embodiments disclosed below, and may be implemented in various forms. Rather, the embodiments are provided to complete the disclosure and to fully convey the concept of the disclosure to one of those ordinarily skilled in the art, and the disclosure will only be defined by the scope of claims. Throughout the specification, like reference numerals denote like components.

In this case, it will be understood that blocks of processing flow diagrams and combinations of the flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create a means for performing functions described in the block(s) of the flow diagram. The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing an instruction means for performing the functions described in the block(s) of the flow diagram. The computer program instructions may also be loaded into a computer or another programmable data processing apparatus, and thus, instructions for operating the computer or another programmable data processing apparatus by generating a computer-executed process when a series of operations are performed in the computer or another programmable data processing apparatus may provide operations for performing the functions described in the block(s) of the flow diagram.

In addition, each block may represent part of a module, segment, or code which includes one or more executable instructions for executing specified logical function(s). It should also be noted that in some alternative implementations, functions mentioned in blocks may occur not in an orderly manner. For example, two blocks illustrated successively may actually be executed substantially concurrently, or the blocks may sometimes be performed in a reverse order according to corresponding functions.

The term “˜unit” used herein implies a software or hardware component, such as a Field Programmable Gate Array (FPGA) or Application Specific Integrated Circuit (ASIC), which performs certain tasks. However, the “—unit” is not limited to the software or hardware component. The “˜unit” may be configured to reside on an addressable storage medium and configured to execute one or more processors. Thus, for example, the “˜unit” may include components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “˜units” may be combined into fewer components or “—units” further separated into additional components and “˜units.” In addition, thereto, the components and “˜units” may be implemented to reproduce one or more Central Processing Units (CPUs) included in a device or a security multimedia card. In addition, the “˜unit” may include one or more processors.

In the following description, a term for identifying an access node, terms referring to network entities, terms referring to messages, a term referring to an interface between network entities, terms referring to various pieces of identification information, or the like are exemplified for convenience of explanation. Therefore, the disclosure is not limited to the terms described below, and other terms having equivalent technical meanings may also be used.

Hereinafter, for convenience of explanation, terms and names defined in the 3rd generation partnership project (3GPP) long term evolution (LTE) standard are used in the disclosure. However, the disclosure is not limited to the terms and names, and is also equally applied to a system conforming to other standards. In the disclosure, a base station may be used interchangeably with an eNB and a gNB for convenience of explanation. That is, the base station described as the eNB may represent the gNB. In the disclosure, the term “terminal” may represent not only handphones, NB-IoT devices, and sensors but also other wireless communication devices.

The disclosure provides a method and apparatus for performing power control in each transmission reception point (TRP) when a physical uplink control channel (PUCCH) repetition transmission is configured in multiple TRPs in a next-generation mobile communication system. In particular, unlike an operation in a frequency range 2 (FR2) in which a base station instructs a terminal to perform the power control used in PUCCH transmission in association with a beam, a method in which the power control is instructed in association with the beam is not applied in a frequency range 1 (FR1) since a single beam is used. With the introduction of the PUCCH repetition transmission through multiple TRPs in the next-generation mobile communication system, there is a need for a method of controlling power in each TRP.

FIG. 1 illustrates a structure of an LTE system according to an embodiment of the present disclosure.

Referring to FIG. 1, as illustrated, a radio access network of the LTE system includes next-generation base stations (e.g., evolved Node Bs (eNBs), Node Bs, or base stations) 105, 110, 115, and 120, a mobility management entity (MME) 125, and a Serving-GateWay (S-GW) 130. A user terminal (e.g., a User Equipment (UE) or a terminal) 135 has access to an external network via the eNBs 105 to 120 and the S-GW 130.

In FIG. 1, the eNBs 105 to 120 may correspond to the legacy node B of a universal mobile telecommunication system (UMTS) system. The eNB is coupled to the UE 135 through a radio channel and performs a more complex role than the legacy node B. In the LTE system, since every user traffic including a real-time service such as voice over IP (VoIP) through an Internet protocol is served through a shared channel, a device for performing scheduling by collecting state information of UEs such as a buffer state, an available transmit power state, a channel state, or the like is required, and the eNBs 105 to 120 may be responsible for this.

In general, one eNB may control a plurality of cells. For example, in order to implement a transmission rate of 100 Mbps, the LTE system may use an orthogonal frequency division multiplexing (OFDM) as a radio access technology in a bandwidth of 20 MHz. In addition, adaptive modulation and coding (AMC) which determines a modulation scheme and a channel coding rate is applied according to the channel state of the UE. The S-GW 130 is a device for providing a data bearer, and may create or remove the data bearer under the control of the MME 125. The MME is a device which is in charge of various control functions as well as a mobility management function for the UE, and may be coupled to a plurality of base stations.

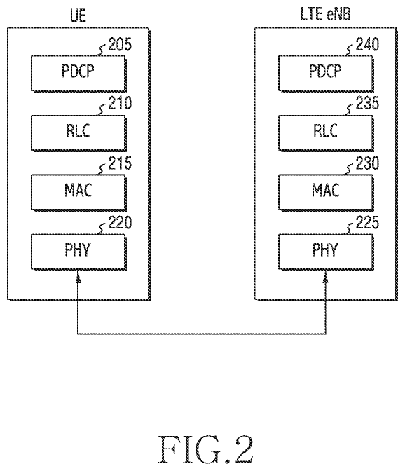

FIG. 2 illustrates a radio protocol structure in an LTE system according to an embodiment of the present disclosure.

Referring to FIG. 2, a radio protocol of the LTE system includes packet data convergence protocols (PDCPs) 205 and 240, radio link controls (RLCs) 210 and 235, and medium access controls (MACs) 215 and 230 respectively in a UE and an eNB. The PDCPs 205 and 240 are in charge of an IP header compression/restoration operation or the like. A main function of the PDCP is summarized as follows. The PDCP is not limited to the following example, and may perform various functions:
Header compression and decompression function (header compression and decompression: Robust header compression (ROHC) only);
User data transfer function (transfer of user data);
In-sequence delivery function (In-sequence delivery of upper layer PDUs at PDCP re-establishment procedure for RLC acknowledge mode (AM));
Reordering function (for split bearers in DC (only support for RLC AM): PDCP PDU routing for transmission and PDCP PDU reordering for reception);
Duplication detection function (duplicate detection of lower layer SDUs at PDCP re-establishment procedure for RLC AM);
Retransmission function (retransmission of PDCP SDUs at handover and, for split bearers in DC, of PDCP PDUs at PDCP data-recovery procedure, for RLC AM);
Ciphering and deciphering function (ciphering and deciphering); and
Timer-based SDU discarding function (Timer-based SDU discard in uplink).

The RLCs 210 and 235 may perform an Automatic Repeated Request (ARQ) operation or the like by reconfiguring a PDCP Packet Data Unit (PDU) with a proper size. A main function of the RLC is summarized as follows. The RLC is not limited to the following example, and may perform various functions:
Data transfer function (Transfer of upper layer PDUs);
ARQ function (error correction through ARQ (only for AM data transfer));
Concatenation, segmentation, and reassembly function (concatenation, segmentation and reassembly of RLC SDUs (only for UM and AM data transfer));
Re-segmentation function (re-segmentation of RLC data PDUs (only for AM data transfer));
Reordering function (reordering of RLC data PDUs (only for UM and AM data transfer);
Duplication detection function (duplicate detection (only for UM and AM data transfer));
Error detection function (protocol error detection (only for AM data transfer));
RLC SDU discarding function (RLC SDU discard (only for UM and AM data transfer)); and
RLC re-establishment function (RLC re-establishment).

The MACs 215 and 230 are coupled to several RLC layer devices configured in one UE, and perform an operation of multiplexing RLC protocol data units (PDUs) to a MAC PDU and demultiplexing the RLC PDUs from the MAC PDU. A main function of the RLC is summarized as follows. The MAC is not limited to the following example, and may perform various functions:
Mapping function (mapping between logical channels and transport channels);
Multiplexing and demultiplexing function (multiplexing/demultiplexing of MAC SDUs belonging to one or different logical channels into/from transport blocks (TB) delivered to/from the physical layer on transport channels);
Scheduling information reporting function (scheduling information reporting);
HARQ function (Error correction through HARQ);
Priority handling function between logical channels (priority handling between logical channels of one UE);
Priority handling function between UEs (priority handling between UEs by means of dynamic scheduling);
MBMS service identification function (MBMS service identification);
Transport format selection function (transport format selection); and
Padding function (padding).

Physical (PHY) layers 220 and 225 perform an operation in which channel coding and modulation are performed on higher layer data and thus an OFDM symbol is created and transmitted through a radio channel or in which demodulation and channel coding are performed on the OFDM symbol received through the radio channel and then are delivered to a higher layer. In addition, for additional error correction, hybrid ARQ (HARQ) is also used in the PHY layer, and whether a packet transmitted in a transmitting end is received is transmitted with 1 bit in a receiving end. This is called HARQ ACK/NACK information. Downlink HARQ ACK/NACK information for uplink transmission is transmitted through a physical hybrid-ARQ indicator channel (PHICH) physical channel, and uplink HARQ ACK/NACK information for downlink transmission may be transmitted through a physical uplink control Channel (PUCCH) or a physical uplink shared channel (PUSCH) physical channel.

Meanwhile, the PHY layer may be constructed of one or multiple frequencies/carriers, and a technology which configures and uses simultaneously the multiple frequencies is called a carrier aggregation (CA) technology. Conventionally, only one carrier has been used for communication between a terminal (or a UE) and a base station (an E-UTRAN NodeB, an eNB), whereas the CA technology additionally uses a primary carrier and one or multiple secondary carriers, thereby significantly increasing a transmission amount by the number of the secondary carriers. Meanwhile, in LTE, a cell in a base station which uses a primary carrier is called a primary Cell (PCell), and a cell in a base station which uses a secondary carrier is called a secondary Cell (SCell).

Although not shown in the figure, a radio resource control (RRC) layer is present above a PDCP layer of each of the UE and the base station. The RRC layer may exchange a configuration control message related to access, measurement, or the like for radio resource control.

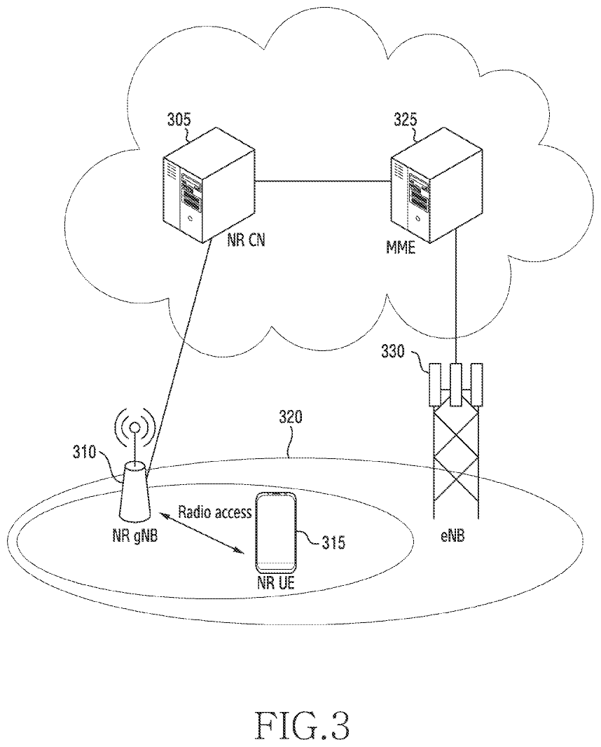

FIG. 3 illustrates a structure of a next-generation mobile communication system according to an embodiment of the present disclosure.

Referring to FIG. 3, a radio access network of a next-generation mobile communication system includes a new radio (NR) node B (NB) 310 and an NR Core Network (CN) (or a Next Generation (NG) CN) 305. An NR UE (or a terminal) 315 may have access to an external network via the NR NB 310 and the NR CN 305.

In FIG. 3, the NR NB 310 corresponds to an evolved Node B (eNB) of the legacy LTE system. The NR NB may be coupled to the NR UE 315 through a radio channel and may provide a more excellent service than the legacy node B. In the next-generation mobile communication system, since every user traffic is served through a shared channel, a device for performing scheduling by collecting state information of UEs such as a buffer state, an available transmit power state, a channel state, or the like is required, and the NR NB 310 is responsible for this. In general, one NR NB 310 controls multiple cells.

At least the existing maximum bandwidth may be used to implement ultra-high speed data transmission compared to the legacy LTE, and a beamforming technology may be additionally combined by using OFDM as a radio access technology. In addition, an AMC scheme which determines a modulation scheme and a channel coding rate in accordance with a channel state of a UE may be applied. The NR CN 305 performs a function such as mobility support, bearer setup, QoS setup, or the like. The NR CN 305 is a device which is in charge of various control functions in addition to a mobility management function for the UE, and is coupled to multiple base stations. In addition, the next-generation mobile communication system may also interwork with the legacy LTE system, and the NR CN 305 may be coupled to an MME 325 via a network interface. The MME 325 is coupled to an eNB 330 which is the legacy base station.

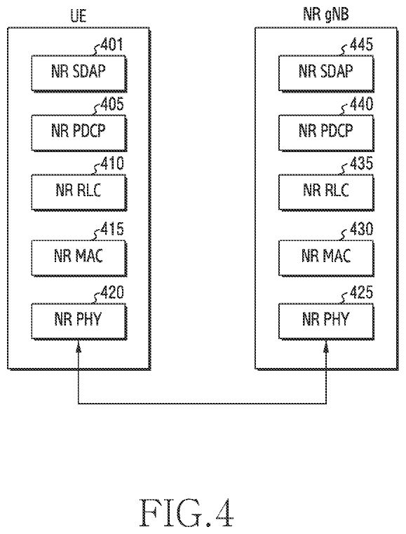

FIG. 4 illustrates a radio protocol structure of a next-generation mobile communication system according to an embodiment of the present disclosure.

Referring to FIG. 4, a radio protocol of the next-generation mobile communication system includes NR service data adaptive protocols (SDAPs) 401 and 445, NR PDCPs 405 and 440, NR RLCs 410 and 435, and NR MACs 415 and 430 respectively in a UE and an NR gNB.

A main function of the NR SDAPs 401 and 445 may include some of the following functions. The NR SDAP is not limited thereto, and may perform various functions:
User data transfer function (transfer of user plane data);
QoS flow and data bearer mapping function for uplink and downlink (mapping between a QoS flow and a DRB for both DL and UL);
QoS flow ID marking function for uplink and downlink (marking QoS flow ID in both DL and UL packets): and
Function of mapping reflective QoS flow to data bearer for uplink SDAP PDUs (reflective QoS flow to DRB mapping for the UL SDAP PDUs).

For an SDAP layer device, whether to use a header of the SDAP layer device or to use a function of the SDAP layer device may be configured in the UE with an RRC message for each PDCP layer device or for each bearer or for each logical channel. When the SDAP header is configured, a non-Access Stratum (NAS) reflective quality of service (QoS) setup I-bit indicator of the SDAP header and an access stratum (AS) reflective QoS setup I-bit indicator may instruct the UE to update or reconfigure mapping information for a QoS flow and data bearer for an uplink and a downlink. The SDAP header may include QoS flow ID information indicating QoS. The QoS information may be used as data processing priority, scheduling information, or the like to smoothly support services.

A main function of the NR PDCPs 405 and 440 may include some of the following functions. The NR PDCP is not limited to the following example, and may perform various functions:
Header compression and decompression function (header compression and decompression: ROHC only;
User data transfer function (transfer of user data);
In-sequence delivery function (in-sequence delivery of upper layer PDUs);
Out-of-sequence delivery function (out-of-sequence delivery of upper layer PDUs);
Reordering function (PDCP PDU reordering for reception);
Duplication detection function (duplicate detection of lower layer SDUs);
Retransmission function (retransmission of PDCP SDUs);
Ciphering and deciphering function (ciphering and deciphering); and
Timer-based SDU discarding function (timer-based SDU discard in uplink).

The reordering function of the NR PDCP device implies a function of reordering PDCP PDUs received from a lower layer, in sequence, based on a PDCP Sequence Number (SN), and may include a function of delivering data to a higher layer in a reordered sequence. Alternatively, the reordering function of the NR PDCP device may include a function of directly delivering the data without considering the order, a function of recording lost PDCP PDUs through reordering, a function of reporting a state for the lost PDCP PDUs to a transmitting side, and a function of requesting for transmission of the lost PDCP PDUs.

A main function of the NR RLCs 410 and 435 may include some of the following functions. The NR RLC is not limited to the following example, and may perform various functions.
Data transfer function (transfer of upper layer PDUs);
In-sequence delivery function (in-sequence delivery of upper layer PDUs);
Out-of-sequence delivery function (out-of-sequence delivery of upper layer PDUs);
ARQ function (error correction through ARQ);
Concatenation, segmentation, and reassembly function (concatenation, segmentation and reassembly of RLC SDUs);
Re-segmentation function (re-segmentation of RLC data PDUs);
Reordering function (reordering of RLC data PDUs);
Duplication detection function (duplicate detection);
Error detection function (protocol error detection);
RLC SDU discarding function (RLC SDU discard); and
RLC re-establishment function (RLC re-establishment).

The in-sequence delivery function of the NR RLC device implies a function of sequentially delivering RLC SDUs received from a lower layer to a higher layer. The in-sequence delivery function may include a function in which, when one RLC SDU is originally received by being segmented into several RLC SDUs, the RLC SDUs are reassembled and delivered. In addition, the in-sequence delivery function may include a function of reordering the received RLC PDUs according to an RLC SN or a PDCP SN, a function of recording lost RLC PDUs through reordering, a function of transmitting a state for the lost PDCP PDUs to a transmitting side, a function of requesting for transmission of the lost PDCP PDUs, a function in which, when there is a lost RLC SDU, only RLC SDUs ahead of the lost RLC SDU are delivered in sequence to a higher layer, a function in which, when a specific timer expires even if the lost RLC SDU exists, all RLC SDUs received before the timer starts are delivered in sequence to the higher layer, and a function in which, when the specific timer expires even if the lost RLC SDU exists, all RLC SDUs received up to now are delivered in sequence to the higher layer.

In addition, the NR RLC device may process the RLC PDUs in the order by which the RLC PDUs are received (in the order by which the RLC PDUs are arrived irrespective of the order of sequence numbers) and deliver the RLC PDUs to a PDCP device irrespective of the order (i.e., out-of-sequence delivery), and when an RLC PDU segment is received, may receive segments stored in a buffer or to be received at a later time and reconstruct the segments into one RLC PDU and then process and deliver the RLC PDU to the PDCP device. The NR RLC layer may not include a concatenation function. In this case, the concatenation function may be performed in an NR MAC layer or may be replaced with a multiplexing function of an NR MAC layer.

The out-of-sequence delivery function of the NR RLC device implies a function of delivering RLC SDUs received from a lower layer directly to a higher layer irrespective of the order. The out-of-sequence delivery function may include a function in whiich, when one RLC SDU is originally received by being segmented into several RLC SDUs, the RLC SDUs are reassembled and delivered, and a function of recording lost RLC PDUs by storing and ordering an RLC SN or PDCP SN of the received RLC PDUs.

The NR MACs 415 and 430 may be coupled to several NR RLC layer devices constructed in one UE, and a main function of the NR MAC may include some of the following functions. The NR MAC is not limited to the following example, and may perform various functions:
Mapping function (mapping between logical channels and transport channels);
Multiplexing and demultiplexing function (Multiplexing/demultiplexing of MAC SDUs);
Scheduling information reporting function (scheduling information reporting);
HARQ function (error correction through HARQ);
Priority handling function between logical channels (priority handling between logical channels of one UE);
Priority handling function between UEs (priority handling between UEs by means of dynamic scheduling);
MBMS service identification function (MBMS service identification);
Transport format selection function (transport format selection); and
Padding function (padding).

NR PHY layers 420 and 425 may perform an operation in which channel coding and modulation are performed on higher layer data and thus an OFDM symbol is created and transmitted through a radio channel or in which demodulation and channel coding are performed on the OFDM symbol received through the radio channel and then are delivered to a higher layer.

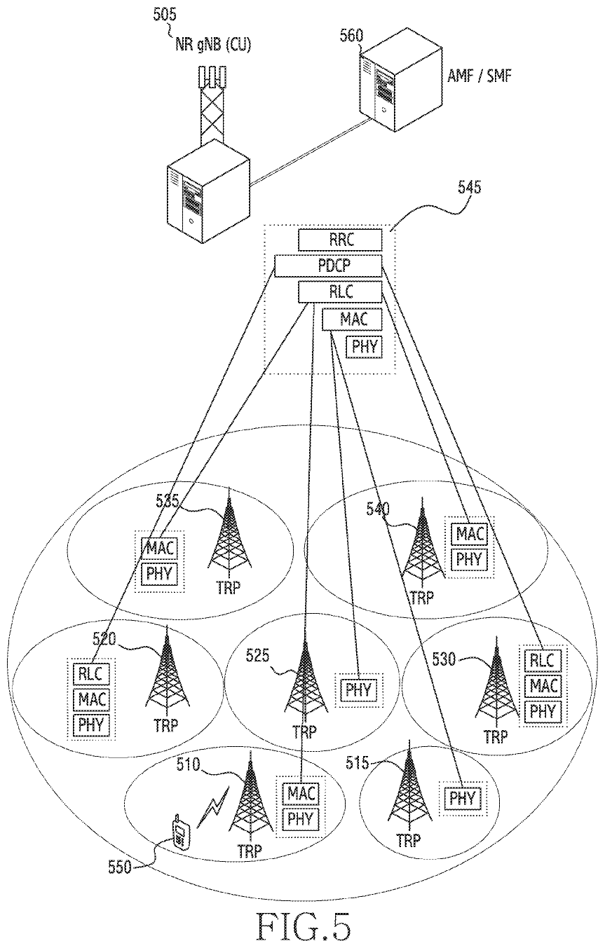

FIG. 5 illustrates a structure of another next-generation mobile communication system according to an embodiment of the present disclosure.

Referring to FIG. 5, a cell served by an NR gNB 505 operating on a beam basis may be constructed of multiple transmission reception points (TRPs) 510, 515, 520, 525, 530, 535, and 540. The TRPs 510 to 540 represent blocks in which some functions of transmitting and receiving a physical signal are separated from the legacy NR eNB, and are constructed of a plurality of antennas. The NR gNB 505 may also be represented by a central unit (CU), and the TRP may also be represented as a distributed unit (DU). A function of the NR gNB 505 may be configured by separating each layer from a layer such as a PDCP/RLC/MAC/PHY layer 545. That is, the TRP may have only the PHY layer and perform a function of that layer (see 515, 525). The TRP may have only the PHY layer and the MAC layer and perform functions of those layers (see 510, 535, 540).

The TRP may have only the PHY layer, the MAC layer, and the RLC layer and perform functions of those layers (see 520, 530). In particular, the TRPs 510 to 540 may use a beamforming technology in which narrow beams are generated in various directions by using a plurality of transmission/reception antennas to transmit and receive data. A UE 550 accesses the NR gNB 505 and an external network through the TRPs 510 to 540. The NR gNB 505 supports connectivity between UEs and a core network (CN), in particular, an AMF/SMF 560, by collecting and scheduling state information of the UEs such as a buffer state, an available transmit power state, a channel state, or the like to provide a service to users.

The disclosure is described based on the structures 515 and 525 in which the TRP has only the PHY layer and performs a function of that layer. However, the TRP is not limited thereto, and may further include at least one of the PDCP layer, the RLC layer, and the MAC layer.

In order to improve a MIMO operation in a next-generation mobile communication system, a UE performs an operation of configuring and activating beam information, e.g., spatial relation, used in PUCCH transmission through RRC and MAC CE control in a FR2 in which transmission is performed using a beam. That is, regarding a PUCCH resource for a specific BWP in one serving cell among multiple pieces of beam information pre-configured with RRC, a MAC CE may be used to update/indicate beam information. In addition, when multiple PUCCH resources are configured and the PUCCH resources are configured as a group, it is also possible to update beam information simultaneously in the multiple serving cells in which the PUCCH resources are delivered. Regarding a beam configuration applied to PUCCH transmission, parameters related to transmit power in PUCCH transmission may also be associated and indicated for each beam in which the beam configuration is indicated. That is, although beam information, e.g., spatial relation, for transmission of the PUCCH resource is indicated in practice, since a power parameter when selecting a corresponding beam has already been provided with an RRC configuration, a beam indication plays a role of indicating the beam and the power parameter together.

However, the aforementioned operation is a MIMO operation (e.g., a transmission operation of the UE in an FR2 band) in which a beam is used by default, and is not applied to a UE transmission operation in an FR1 band in which a single beam is used in omni-directional radiation. This is because, in the FR1 band, the UE does not have to operate by distinguishing power control for a specific beam. With an introduction of multiple TRPs (hereinafter, mTRP), an embodiment of the disclosure describes a specific operation regarding how to configure and activate PUCCH transmit power in each TRP, when a scheme of improving reliability by repeatedly transmitting a PUCCH through every mTRP is applied.

In the disclosure, the FR1 band implies a band ranging from 410 MHz to 7125 MHz in which an NR system operates, and the FR2 band may include both a band ranging from 24250 MHz to 52600 MHz for delivering a radio resource by using a directional beam and a band ranging from 52600 MHz to 71000 MHz which is an extended FR2 band.

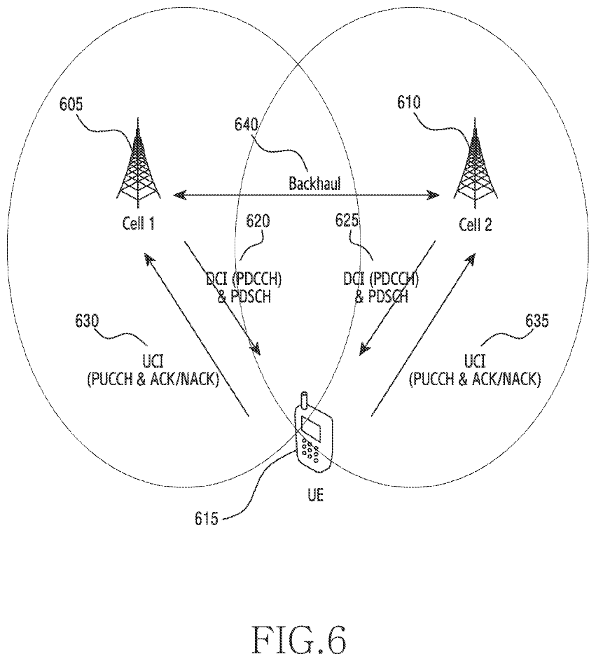

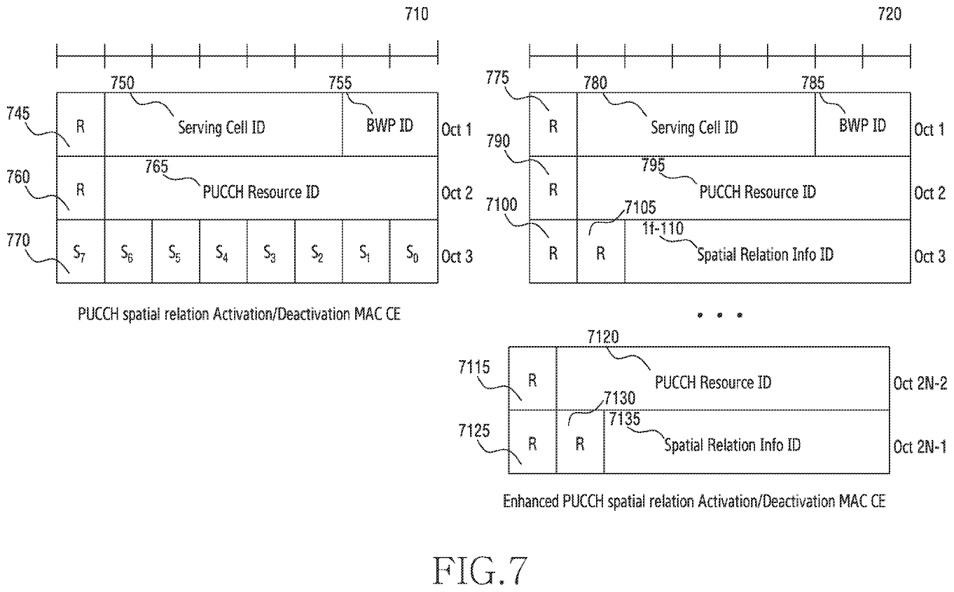

FIG. 6 and FIG. 7 illustrate a structure of a next-generation mobile communication system and a scenario of applying a PUCCH resource configuration and beam activation operation according to an embodiment of the present disclosure.

Referring to FIG. 6, there may be multiple cells 605 and 610 served by an NR gNB operating on a beam basis. A UE 615 may receive a configuration for another serving cell (a cell 2) 610 in a state of being connected to a specific cell (a cell 1) 605, and may use a CA operation so that data transmission and reception are possible from the multiple cells. An NR system uses an RRC control message to provide a PDCCH configuration and PDSCH configuration for each serving cell and each BWP, and thus provides configuration information for receiving a downlink control signal and a data signal and reception beam configuration information related thereto (steps 620, 625). In addition, thereto, the RRC control message may be used to provide PUCCH-Config for each serving cell and each BWP, and in a corresponding configuration, i.e., PUCCH-Config, a PUCCH resource configuration and a transmission beam configuration related thereto may be configured simultaneously (steps 630, 635). In one cell group, one PUCCH SCell may be configured in addition to the PCell/PSCell.

In the step of configuring the PUCCH resource through the RRC control message, a method of configuring the PUCCH resource is as following examples.

In one example of PUCCH resource sets, as a unit by which PUCCH resources having the same payload are aggregated, PUCCH resources existing in one PUCCH resource set have the same payload size. Up to 4 PUCCH resource sets may be configured for each BWP.

In one example of PUCCH resources, configuration information for an actual PUCCH resource is included, and up to 32 PUCCH resources may be configured for each PUCCH resource set. The PUCCH resources use 128 indices in total.

In one example of spatial relations info, it indicates beam information used to transmit PUCCH resources in practice, and one beam may be selected from among SSB, CSI-RS, and SRS. Up to 8 pieces of beam information may be configured for each BWP. In Rel-16, the number of corresponding beams is increased from 8 to 64 as shown in TABLE 1.

TABLE 1
Spatial relation information

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | PUCCH-SRS |
| | } |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

| | |
|---|---|
| PUCCH-SpatialRelationInfoExt-r16 ::= | SEQUENCE { |
| pucch-SpatialRelationInfoId-v1610 | PUCCH-SpatialRelationInfoId-v1610 |

OPTIONAL, -- Cond SetupOnly

| | |
|---|---|
| pucch-PathlossReferenceRS-Id-v1610 | PUCCH-PathlossReferenceRS-Id- |

v1610 OPTIONAL, --Need R
...
}

| | |
|---|---|
| PUCCH-SRS ::= | SEQUENCE { |
| resource | SRS-ResourceId, |
| uplinkBWP | BWP-Id |

}

| | |
|---|---|
| PUCCH-SpatialRelationInfoId ::= | INTEGER |

(1..maxNrofSpatialRelationInfos)

| | |
|---|---|
| PUCCH-SpatialRelationInfoId-r16 ::= | INTEGER (1..maxNrofSpatialRelationInfos- |

r16)

| | |
|---|---|
| PUCCH-SpatialRelationInfoId-v1610::= | INTEGER maxNrofSpatialRelationInfos- |

plus-1..maxNrofSpatialRelationInfos-r16)

Based on RRC configuration information related to the PUCCH resource, the UE may deliver a PUCCH/ACK/NACK signal in response to a downlink signal. In this case, initial beam information related to each PUCCH resource may be beam information (SSB in an initial RACH operation) used in an initial RRC connection procedure, and a MAC CE is used at a later time to update beam information related to a specific PUCCH resource. That is, a PUCCH spatial relation activation/deactivation MAC CE is used. The MAC CE is described with reference to FIG. 7. Parameter information described below is applied to a basic PUCCH spatial MAC CE structure (see 710) and an improved PUCCH spatial MAC CE structure (see 720):
Reserved bit (included for byte alignment; 745, 760, 775, 790, 7100, 7105, 7115, 7125, 7130);
Serving cell ID (5 bits; 750, 780);
BWP ID (2 bits; 755, 785);
PUCCH resource ID (7 bits; 765, 795, 7120);
Spatial relation bitmap (8 bits: only one of up to 8 bitmaps is activated, 770); and
Spatial relation index (6 bits; used to distinguish 64 beam identifiers, 7110, 7135).

The aforementioned MAC CE may indicate a specific beam through which a PUCCH resource in a serving cell and BWP is to be delivered. When the MAC CE is received, the UE updates and applies associated beam information of a related PUCCH resource. In addition, power control parameters associated with a specific spatial relation are also updated and applied together in an RRC configuration. As described above, since PUCCH configuration information is provided for each BWP and it is possible to configure up to 128 PUCCH resources, in order to update beam information for the configured 128 PUCCH resources, it may be necessary to perform the update up to 128 times through the MAC CE. Therefore, there may be an increase in latency, and signaling overhead is also significant. In an embodiment, to solve this problem, a PUCCH group (simultaneousSpatial-UpdatedList1-r16, simultaneousSpatial-UpdatedList2-r16 in the following ASN.1 code) may be configured (in CellGroupConfig) with RRC.

When it is indicated that a PUCCH resource belonging to a corresponding group is to be activated by using the aforementioned MAC CEs (see 710, 720), the UE performs the same activation operation for all PUCCH resources of the PUCCH group to which the corresponding PUCCH resource belongs. That is, beams for multiple PUCCH resources are changed/updated simultaneously, and power parameters are also changed according to the beam change/update. That is, it is possible to update the multiple beams and perform power control by using one MAC CE without having to change a beam several times, thereby reducing latency.

TABLE 2
Call group configuration

| | |
|---|---|
| CellGroupConfig ::= | SEQUENCE { |
| cellGroupId | CellGroupId, |
| rlc-BearerToAddModList | SEQUENCE (SIZE(1..maxLC- |
| ID)) OF RLC-BearerConfig | OPTIONAL, -- Need N |
| rlc-BearerToReleaseList | SEQUENCE (SIZE(1..maxLC- |
| ID)) OF LogicalChannelIdentity | OPTIONAL, -- Need N |
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE |
| (1..maxNrofSCells)) OF SCellConfig | OPTIONAL, -- |

Need N

| | |
|---|---|
| sCellToReleaseList | SEQUENCE (SIZE |
| (1..maxNrofSCells)) OF SCellIndex | OPTIONAL, -- |

```
Need N
  ...,
  [[
```

| | |
|---|---|
| reportUplinkTxDirectCurrent | ENUMERATED {true} |

```
OPTIONAL -- Cond BWP-Reconfig
  ]],
  [[
```

| | |
|---|---|
| bap-Address-r16 | BIT STRING (SIZE (10)) |

OPTIONAL, -- Need M

| | |
|---|---|
| bh-RLC-ChannelToAddModList-r16 | SEQUENCE |

(SIZE(1..maxBH-RLC-ChannelID-r16)) OF BH-RLC-ChannelConfig-r16 OPTIONAL,
-- Need N

| | |
|---|---|
| bh-RLC-ChannelToReleaseList-r16 | SEQUENCE (SIZE(1..maxBH- |
| RLC-ChannelID-r16)) OF BH-RLC-ChannelID-r16 | OPTIONAL, -- Need N |
| flc-TransferPath-r16 | ENUMERATED {lte, nr, both} |

OPTIONAL, -- Need M

| | |
|---|---|
| simultaneousTCI-UpdateList1-r16 | SEQUENCE (SIZE |
| (1..maxNrofServingCellsTCI-r16)) OF ServCellIndex | OPTIONAL, -- Need |

R

| | |
|---|---|
| simultaneousTCI-UpdateList2-r16 | SEQUENCE (SIZE |
| (1. .maxNrofServingCellsTCI-r16)) OF ServCellIndex | OPTIONAL, -- Need |

R

| | |
|---|---|
| simultaneousSpatial-UpdatedList1-r16 | SEQUENCE (SIZE |
| (1..maxNrofServingCellsTCI-r16)) OF ServCellIndex | OPTIONAL, -- Need |

R

| | |
|---|---|
| simultaneousSpatial-UpdatedList2-r16 | SEQUENCE (SIZE |
| (1..maxNrofServingCellsTCI-r16)) OF ServCellIndex | OPTIONAL, -- Need |

R

| | |
|---|---|
| uplinkTxSwitchingOption-r16 | ENUMERATED {switchedUL, |
| dualUL} | OPTIONAL, -- Need R |
| uplinkTxSwitchingPowerBoosting-r16 | ENUMERATED {enabled} |

```
OPTIONAL -- Need R
  ]],
  [[
```

| | |
|---|---|
| reportUplinkTxDirectCurrentTwoCarrier-r16 | ENUMERATED {true} |

OPTIONAL -- Need N
]]
}

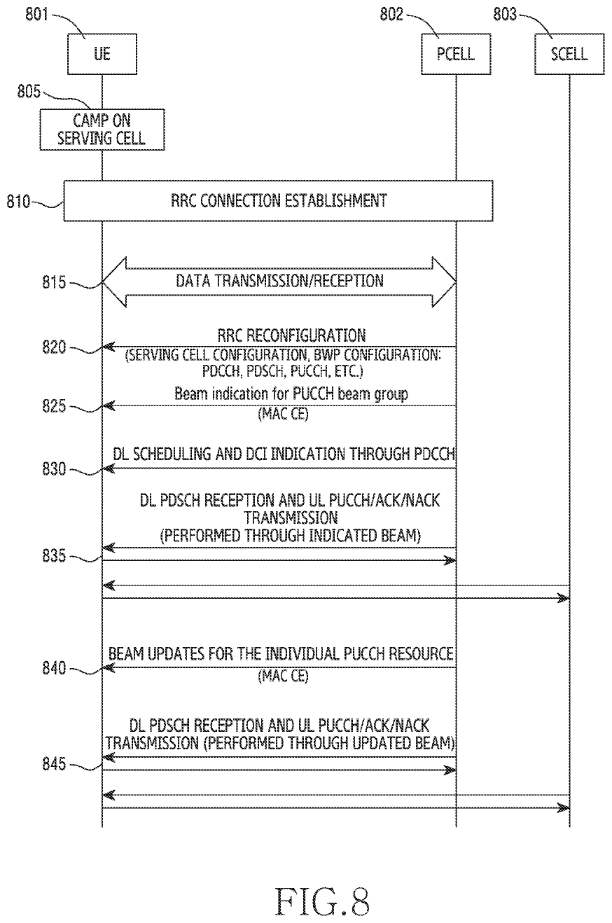

FIG. 8 illustrates an operation of updating transmission beams simultaneously by individually controlling and grouping multiple PUCCH resources configured through multiple serving cells and BWPs in a NR system according to an embodiment of the present disclosure.

The NR system is designed to perform data transmission and reception of a UE and a gNB by using a beam having directivity. When the multiple PUCCH resources are configured as one group, a method of supporting a beam update operation for the multiple PUCCH resources simultaneously is supported, by configuring activation/deactivation of a beam (TCI state, PUCCH spatial relation) for a specific BWP in one serving cell.

When multiple serving cells are configured as one group and a PUCCH resource belonging to a corresponding cell is activated/deactivated using the MAC CE, beam information and power parameters applied to the entire PUCCH resources of the multiple cells included in the group may be simultaneously updated (group configuration per cell group).

A UE 801 in an RRC_IDLE mode finds for a suitable cell to camp on a corresponding gNB 802 (step 805), and access a PCell of the gNB 802 for a reason of occurrence of data to be sent, or the like (see 810). The RRC_IDLE mode is a state in which it is not possible to transmit data since a network is not connected for UE power saving or the like, and a transition to an RRC_CONNECTED mode is necessary for data transmission. Herein, the camping implies that the UE stays in a corresponding cell and receives a paging message to determine whether data is coming through a downlink. When the UE succeeds in the procedure of accessing the gNB 802, the UE switches to the RRC_CONNECTED mode, and the UE in the RRC_CONNECTED mode is capable of performing data transmission and reception with respect to the gNB (step 815).

In step 820, the gNB in the RRC_CONNECTED state delivers configuration information (ServingCellConfig) for configuring multiple serving cells and BWPs to the UE through an RRC message. The RRC message may include configuration information (PDCCH-Config, PDSCH-Config) for reception through a PDCCH and a PDSCH and configuration information (PUCCH-Config) for PUCCH transmission, and may include a BWP configuration (BWP-Uplink, BWP-Downlink), a CORESET configuration, a scrambling configuration, a TCI state configuration (TCI-State in PDSCH-Config), or the like. In particular, the TCI state-related configuration is provided for each serving cell and downlink BWP, and is included in each of PDCCH-Config and PDSCH-Config. A beam configuration for PUCCH resource transmission is included in PUCCH-Config. A PUCCH resource, a PUCCH resource set, a spatial relation info, or the like may be configured in the PUCCH configuration. The PUCCH configuration has been described with reference to FIG. 6 and FIG. 7. 8 or 64 pieces of spatial relation info may be configured for the PUCCH resource in step 820, and a group configuration of cells for updating a PUCCH resource transmission beam belonging to multiple serving cells may be provided simultaneously in CellGroupConfig.

Instead of pre-configuring multiple serving cell groups applicable to the same transmission beam in step 820, that is, in the step of RRC configuration, an operation of updating a beam applied to the multiple PUCCH resource with the MAC CE may be supported. This is possible when a specific cell is not included in a cell group configuration for simultaneous PUCCH resource beam update of CellGroupConfig or when the cell group configuration is not included.

In step 825, the gNB delivers the MAC CE for indicating/updating a transmission beam for the PUCCH resource configured with the RRC configuration information. The MAC CE used in this step uses a MAC CE indicating simultaneous transmission beam update for PUCCH resources of the multiple serving cells. Based on PUCCH resource serving cell group information configured in the RRC control message, a PUCCH resource of one cell requiring an update may be included among the multiple cells. In this case, although beam information update of the PUCCH resource for one cell is indicated, the same operation is applied to all cells belonging to a corresponding group. A MAC CE structure and operation has been described in detail with reference to FIG. 6 and FIG. 7.

In step 830, the gNB may deliver a downlink control to the UE through a downlink (DL) data scheduling and a DL control indicator. The gNB in step 830 indicates a reception beam of the UE along with an indication for a downlink beam.

In step 835, data transmission and reception to which corresponding transmission and reception resources are applied are performed through a downlink beam (TCI state) and an uplink beam (PUCCH resource transmission beam) indicated in steps 825 and 830. That is, the UE performs uplink/downlink data reception through a beam configured for communication with the gNB. In particular, ACK/NACK transmission may be performed through a PUCCH resource.

In step 840, the gNB may deliver the MAC CE again for the purpose of updating the previously delivered MAC CE, and may update a beam to be activated and deactivated herein. Step 840 relates to an operation of updating a beam for an individual PUCCH resource instead of updating the beam simultaneously for multiple PUCCH resources. That is, it is possible to activate a beam update simultaneously for the multiple PUCCH resources in step 825 and to update a beam for an individual PUCCH resource in step 840. As described above, this is possible as described above, when a serving cell indicated in step 840 is not designated as a cell group. In step 845, data transmission and reception to which corresponding transmission and reception resources are applied are performed through a downlink beam (TCI state) and an uplink beam (PUCCH resource transmission beam). That is, the UE performs uplink/downlink data reception through a beam configured for communication with the gNB. In particular, ACK/NACK transmission may be performed through a PUCCH resource.

The following embodiments describe an operation of configuring, indicating, and updating power control parameters, in particular, in FR1, through the RRC and the MAC CE, when PUCCH retransmission is applied through the mTRP. Although data reception performance for multiple PDSCHs has been improved with the introduction of the mTRP in the NR system, performance for the PDCCH and the PUCCH/PUSCH has not been improved. The disclosure describes a function of increasing reliability of PUCCH transmission of the UE by repeatedly transmitting the PUCCH in the mTRP, as a scheme of improving reliability of the PUCCH with the introduction of the mTRP. Since the UE has to transmit a PUCCH resource through multiple TRPs, there is a need to clarify an operation regarding how to configure transmit power differently from the existing single PUCCH transmission.

In particular, since multiple PUCCH transmissions may occur simultaneously in the same time domain through different TRPs, PUCCH transmit power control is further required. In addition, as described above, the FR1 does not support an operation of configuring and indicating a transmission beam in association with a transmission beam since a single beam is used for omni-directional radiation without having to use a beam. Therefore, there is no PUCCH transmit power control method for a case where PUCCH repetition transmission in the mTRP operates in the FR1. An operation for this case is described below.

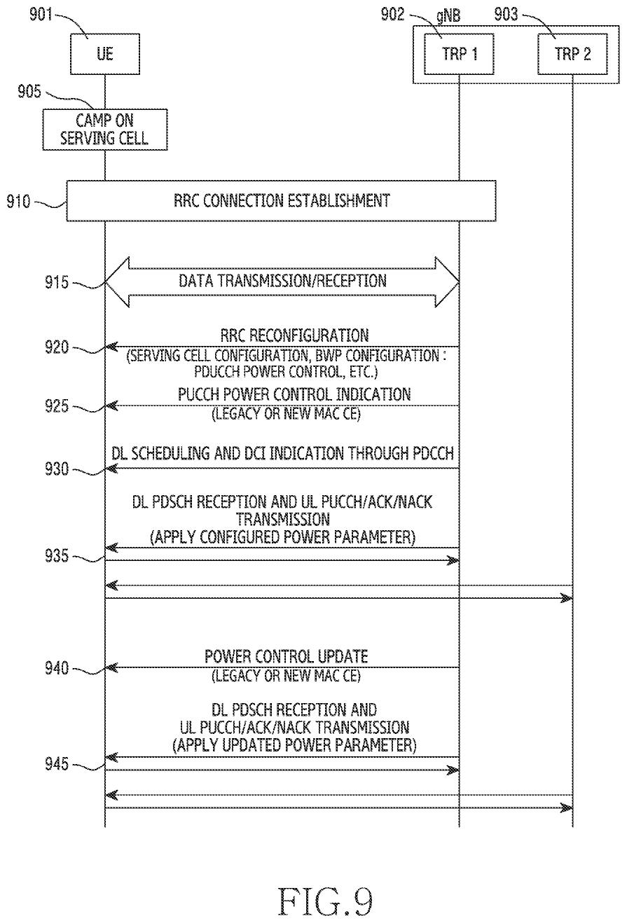

FIG. 9 illustrates an operation of configuring and updating power control for PUCCH resource transmission when PUCCH repetition transmission is configured in multiple TRPs in an NR FR1 system according to an embodiment of the present disclosure.

A UE 901 in an RRC_IDLE mode finds for a suitable cell to camp on a corresponding gNB 902 (step 905), and access a PCell of the gNB 902 for a reason of occurrence of data to be sent, or the like (see 910). The RRC_IDLE mode is a state in which it is not possible to transmit data since a network is not connected for UE power saving or the like, and a transition to an RRC_CONNECTED mode is necessary for data transmission. Herein, the camping implies that the UE stays in a corresponding cell and receives a paging message to determine whether data is coming through a downlink. When the UE succeeds in the procedure of accessing the gNB 902, the UE switches to the RRC_CONNECTED mode, and the UE in the RRC_CONNECTED mode is capable of performing data transmission and reception with respect to the gNB (step 915).

In step 920, the gNB in the RRC_CONNECTED state delivers configuration information (ServingCellConfig) for configuring multiple serving cells and BWPs to the UE through an RRC message. The RRC message may include configuration information (PDCCH-Config, PDSCH-Config) for reception through a PDCCH and a PDSCH and configuration information (PUCCH-Config) for PUCCH transmission, and may include a BWP configuration (BWP-Uplink, BWP-Downlink), a CORESET configuration, a scrambling configuration, a TCI state configuration (TCI-State in PDSCH-Config), or the like. In particular, the TCI state-related configuration is provided for each serving cell and downlink BWP, and is included in each of PDCCH-Config and PDSCH-Config. A beam configuration for PUCCH resource transmission is included in PUCCH-Config. A PUCCH resource, a PUCCH resource set, a spatial relation info, or the like may be configured in the PUCCH configuration. The PUCCH configuration has been described with reference to FIG. 6 and FIG. 7.

In an embodiment, multiple TRPs may be configured in step 920, and the RRC message may include a configuration for PUCCH repetition transmission through the multiple TRPs. At the same time, when the UE is instructed to operate in the FR1 band (when a frequency band of a serving cell is the FR1 band and related configuration information is provided with RRC), in step 920, a configuration for power control parameters for PUCCH transmission applied to PUCCH repetition transmission through the mTRP in the FR1 may be provided together. The configuration may be configured through a separate RRC information element (IE), or may be applied by reusing and redefining the legacy RRC IE. An operation of configuring and activating a power control parameter for PUCCH transmission applied to PUCCH repetition transmission through the mTRP in the FR1 is described below.

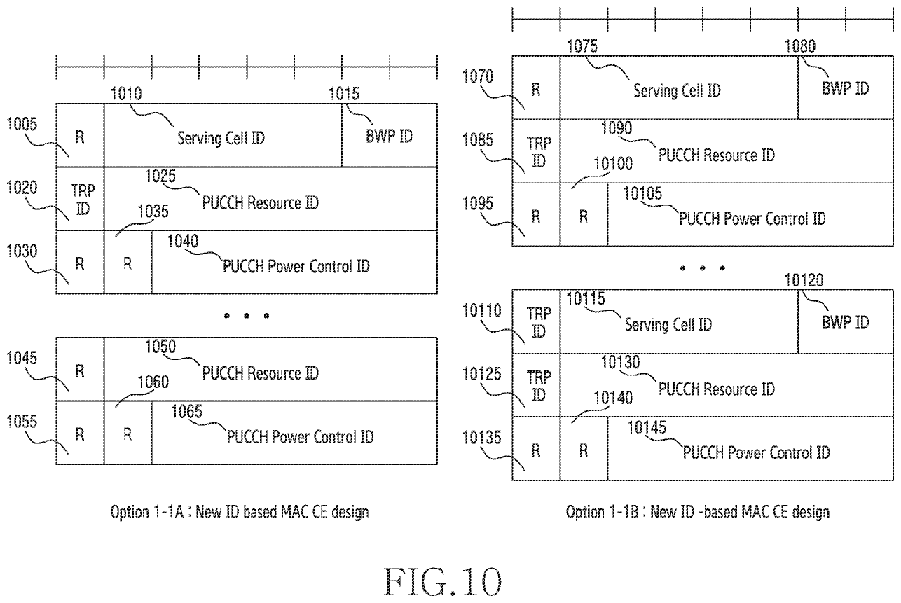

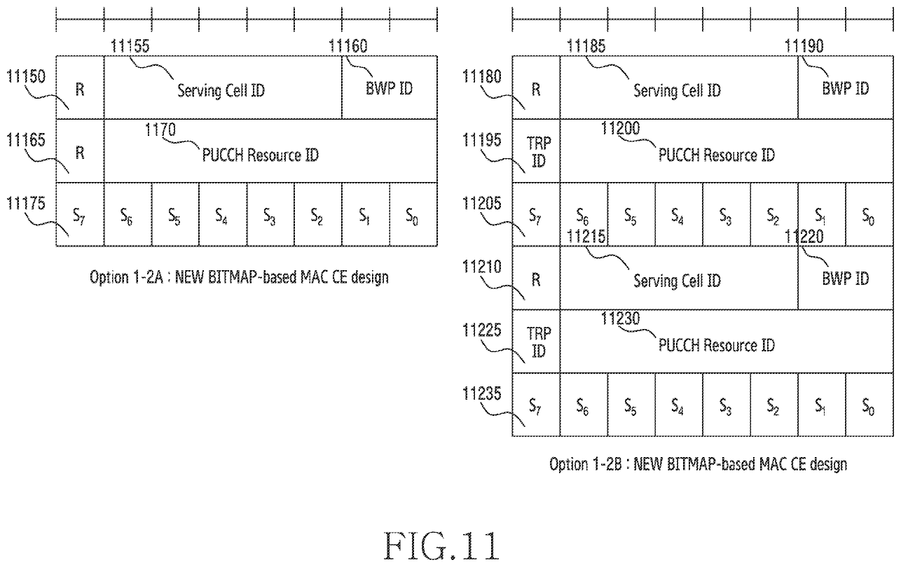

In one embodiment, new dedicated RRC IE and new MAC CE are provided (e.g., FIG. 10, FIG. 11).

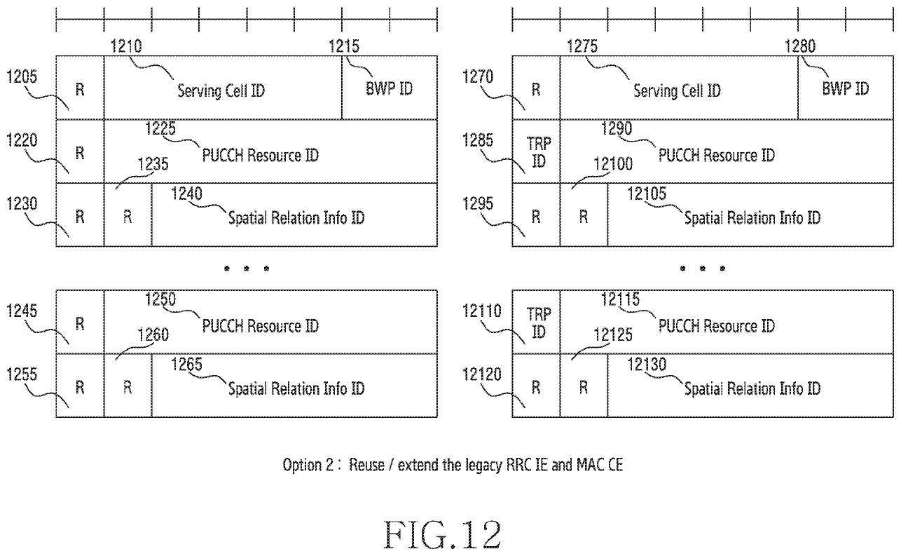

In one embodiment, an RRC IE is reused and redefined to be applied to FR2 band, and apply legacy MAC CE. (e.g., FIG. 12).

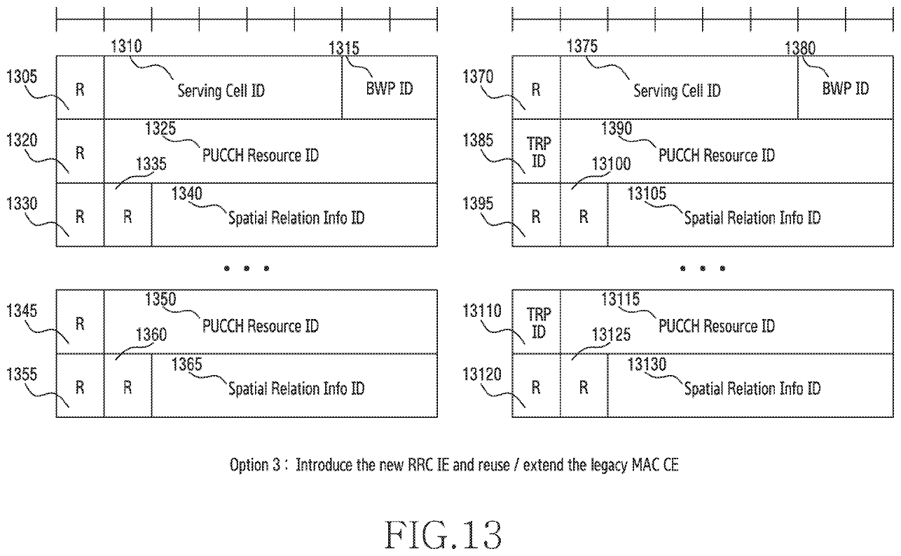

In one embodiment, a new dedicated RRC IE is provided and a legacy MAC CE is applied. (e.g., FIG. 13).

A group configuration of cells for simultaneously updating a PUCCH resource transmission beam belonging to multiple cells in CellGroupConfig may be provided. A list applied to FR2 may be directly applied to simultaneously update power parameter control in the FR1, and an additional list for simultaneously updating the power parameter control in the FR1 may be provided. In addition, when such an RRC configuration is provided, initial values applied to initial PUCCH transmission may be specific values of PUCCH transmit power parameters to be subjected to the RRC configuration, and are configurable by using at least one of the following embodiments.

In one embodiment, for an initial parameter configuration, d a value applied to TRP1 and TRP2 in a to-be-configured PUCCH transmit power parameter list is defined as a parameter to be associated with a first index and a second index (a first item of the to-be-configured PUCCH transmit power parameter list may be a PUCCH transmit power parameter to be applied to TRP1, and a second item may be a PUCCH transmission parameter to be applied to TRP2).

In one embodiment, for an initial parameter configuration, an index for the PUCCH transmit power parameter to be applied to TRP1 and TRP2 is explicitly configured

In one embodiment, for an initial parameter configuration, the PUCCH transmit power parameter to be applied to TRP1 and TRP2 is defined as the same value (e.g., apply a power control parameter included in a to-be-configured first PUCCH transmission parameter index).

In step 920, that is, a power parameter update operation to be applied to multiple PUCCH resources may be supported in a MAC CE without having to pre-configure multiple serving cell groups to which the same PUCCH transmit power control is applicable in the RRC configuration. This is possible when a specific cell is not included in a cell group configuration for the simultaneous PUCCH resource beam update of corresponding CellGroupConfig or the corresponding group configuration is not included. In step 925, the gNB delivers a MAC CE for indicating/updating a power control parameter for a PUCCH resource configured with the RRC configuration information. The MAC CE used in this step may use a MAC CE indicating the simultaneous transmit power parameter update for PUCCH resources of the multiple serving cells. Based on PUCCH resource serving cell group information configured in the RRC control message, a PUCCH resource of one cell requiring an update may be included among the multiple cells. In this case, although the PUCCH power control parameter update of the PUCCH resource for one cell is indicated, the same operation is applied to all cells belonging to a corresponding group. A MAC CE structure and operation will be described in detail with reference to FIG. 10, FIG. 11, FIG. 12, and FIG. 13.

Data transmission and reception to which corresponding transmission and reception resources are applied are performed through a downlink beam (TCI state) and an uplink beam (PUCCH resource transmission beam) indicated in step 925 and 930. That is, the UE performs uplink/downlink data reception through a beam configured for communication with the gNB. In particular, ACK/NACK transmission may be performed through PUCCH resources in multiple TRPs.

In step 940, the gNB may deliver the MAC CE again for the purpose of updating the previously delivered MAC CE, and may update a PUCCH power parameter to be activated and deactivated herein. Step 940 relates to an operation of updating a PUCCH power parameter for an individual PUCCH resource instead of updating the PUCCH power parameter simultaneously for multiple PUCCH resources. That is, it is possible to activate a beam update simultaneously for multiple PUCCH resources in step 925 and to update the PUCCH power parameter for an individual PUCCH resource in step 940. As described above, this is possible when a serving cell indicated in step 940 is not designated as a cell group. In step 945, data transmission and reception to which corresponding transmission and reception resources are applied are performed through a downlink beam (TCI state) and an uplink beam (PUCCH resource transmission beam). That is, the UE performs uplink/downlink data reception through a beam configured for communication with the gNB. In particular. ACK/NACK transmission may be performed through PUCCH resources of multiple TRPs.

FIG. 10 and FIG. 11 illustrate a MAC CE structure for a UE operation in which a PUCCH resource power control parameter for each TRP is configured with an RRC control message and an update is applied through a MAC CE when PUCCH repetition transmission in FR1 is configured through multiple TRPs according to an embodiment of the present disclosure.

An embodiment described herein (e.g., FIG. 9) in which the power control parameter is configured and activated for PUCCH transmission is applied to PUCCH repetition transmission through the mTRP in FR1. It is described that a new dedicated RRC IE (PUCCH-PowerControlFR1-r17) is introduced, and anew MAC CE for updating PUCCH power control parameters dedicated for FR1 in the mTRP of a corresponding RRC configuration is introduced.

First, when FR1-dedicated PUCCH power control parameters in the mTRP are configured through the RRC configuration, the parameters may be configured as follows.
Power control identifier (pucch-PowerControlFR1-id-r17) for PUCCH resource in the mTRP: A value representing the following actual parameters, as an identifier for distinguishing sets of PUCCH power control parameters. For example, 64 identifiers may be configured, and other values are also possible:
PUCCH pathloss reference RS identifier (pucch-PathlossReferenceRS-Id-r17): An identifier indicating a pathloss reference RS to be referred in PUCCH transmission;
A P0 value for PUCCH (UE transmit power, p0-PUCCH-Id-r17); and
Closed loop identifier (closedLoopIndex-r17) to be applied to PUCCH transmit power control.

A structure of the aforementioned RRC parameter and new RRC IE may be expressed by ASN.1 as shown below TABLE 3.

TABLE 3
Power control information

| | |
|---|---|
| PUCCH-PowerControlFR1-r17 ::= | SEQUENCE { |
| pucch-PowerControlFR1-id-r17 | PUCCH-PowerControlFR1-id-r17, |
| pucch-PathlossReferenceRS-Id-r17 | PUCCH-PathlossReferenceRS-Id-r17, |
| p0-PUCCH-Id-r17 | P0-PUCCH-Id, |
| closedLoopIndex-r17 | ENUMERATED { i0, i1 } |

}

| | |
|---|---|
| PUCCH-PowerControlFR1-id-r17 | ::= INTEGER (0.. |

maxNrofPUCCH-PowerControlFR1-1-r17)

| | |
|---|---|
| PUCCH-PathlossReferenceRS-Id-r17 ::= | INTEGER (0.. |

maxNrofPUCCH-PathlossReferenceRSs-1-r16)

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |

The initial PUCCH power control parameter values applied to the TRP1 and the TRP2 may be specific values, and it is possible to apply at least one of the following embodiments.

In one embodiment, for an initial parameter configuration, a value applied to TRP1 and TRP2 in a to-be-configured PUCCH transmit power parameter list (PUCCH-PowerControlFR1-r17) is defined as a parameter to be associated with a first index and a second index (a first item of the to-be-configured PUCCH transmit power parameter list may be a PUCCH transmit power parameter to be applied to TRP1, and a second item may be a PUCCH transmission parameter to be applied to TRP2).

In one embodiment, an initial parameter configuration, an index for the PUCCH transmit power parameter to be applied to TRP1 and TRP2 is explicitly configured.

In one embodiment, for an initial parameter configuration, the PUCCH transmit power parameter to be applied to TRP1 and TRP2 is defined as the same value (e.g., apply a power control parameter included in a to-be-configured first PUCCH transmission parameter index).

MAC CE structures described below relate to the MAC CE operation for dynamically instructing the UE to update the PUCCH transmit power parameters when PUCCH repetition transmission is performed through the mTRP by applying the aforementioned RRC configuration. In the embodiment 1, the MAC CE may be designed to have a different structure depending on how a size of a power control identifier (hereinafter, also referred to as a PUCCH power control ID) for the PUCCH resource in the mTRP in practice, and a possible method is described with reference to FIG. 10 and FIG. 11.

In one example for MAC CE design, MAC CE design based on PUCCH power control identifier is provided:
Serving cell identifier (1010, 1075, 10115): Serving cell ID to which a configuration for a PUCCH resource of a UE is applied (i.e., a cell identifier of ServingCellConfig in which a PUCCH configuration is included);
BWP identifier (1015, 1080, 10120): As a BWP identifier belonging to a serving cell, a BWP ID to which a configuration for a PUCCH resource of a UE is applied (i.e., a BWP identifier of ServingCellConfig in which a PUCCH configuration is included);
TRP identifier (1020, 1085, 10125): TRP ID in which a PUCCH resource is pre-configured, which is applied when a PUCCH resource configuration is explicitly distinguished for each TRP. When the TRP ID is applied to each TRP by splitting the PUCCH resource ID, a corresponding field is configured with a reserved bit (when the TRP distinction is possible in the PUCCH resource ID, or when the TRP distinction is not necessary);
PUCCH resource identifier (1025, 1050, 1090, 10130): PUCCH resource configuration identifier for PUCCH transmission, which may be distinguished for each TRP by splitting a PUCCH resource ID, or the PUCCH resource ID may be configured for each TRP ID;
PUCCH power control identifier (1040, 1065, 10105, 10145): As a power control identifier for a PUCCH resource in the mTRP, it is an identifier for distinguishing a set in which power control parameters are aggregated in PUCCH repetition transmission at an FR1 band; and
Reserved bit (1005, 1030, 1035, 1045, 1055, 1060, 1070, 1095, 10100, 10110, 10135, 10140).

When a transmission for a PUCCH resource configured with TRP in across carrier is performed in the option 1-1, a serving cell and a BWP are additionally indicated to indicate the serving cell and BWP to which each TRP belongs. To distinguish this, the option 1-1B may be designed to be different from the option 1-1A. That is, BWP information and a serving cell in which PUCCH transmission in each TRP is configured may be added.

In one example, for a MAC CE design, MAC CE design based on PUCCH power control bitmap is provided;
Serving cell identifier (11155, 11185, 11215): Serving cell ID to which a configuration for a PUCCH resource of a UE is applied (i.e., a cell identifier of ServingCellConfig in which a PUCCH configuration is included);
BWP identifier (11160, 11190, 11220): As a BWP identifier belonging to a serving cell, a BWP ID to which a configuration for a PUCCH resource of a UE is applied (i.e., a BWP identifier of ServingCellConfig in which a PUCCH configuration is included);
TRP identifier (11195, 11225): TRP ID in which a PUCCH resource is pre-configured, which is applied when a PUCCH resource configuration is explicitly distinguished for each TRP. When the TRP ID is applied to each TRP by splitting the PUCCH resource ID, a corresponding field is configured with a reserved bit (when the TRP distinction is possible in the PUCCH resource ID, or when the TRP distinction is not necessary);
PUCCH resource identifier (11170, 11205, 11230): PUCCH resource configuration identifier for PUCCH transmission, which may be distinguished for each TRP by splitting a PUCCH resource ID, or the PUCCH resource ID may be configured for each TRP ID;
PUCCH power control identifier (11175, 11235): As a power control identifier for a PUCCH resource in the mTRP, which is an identifier mapped in a bitmap format, it is an identifier for distinguishing a set in which power control parameters are aggregated in PUCCH repetition transmission at an FR1 band. A case where a size of the PUCCH power control identifier is less than or equal to 8 bits has been exemplified, and it may also be applied to a case where the size is set to 16 bits greater than 8 bits, by extending to 2 bytes. That is, it is possible to extend to a greater bitmap size; and
Reserved bit (11150, 11165, 11180, 11210).

When transmission for a PUCCH resource configured with TRP in a cross carrier is performed in the option 1-2, a serving cell and a BWP are additionally indicated to indicate the serving cell and BWP to which each TRP belongs. To distinguish this, the option 1-2B may be designed to be different from the option 1-2A. That is, BWP information and a serving cell in which PUCCH transmission in each TRP is configured may be added.

As described above, the options 1-1 and 1-2 are indicated by referring to a newly defined RRC IE, and are characterized in that information related to a beam is not included. This is to quickly update only the PUCCH power control parameter to the MAC CE without having to perform power control interworking with the beam since the beam is not distinguished when operating unlike in the FR2 band.

FIG. 12 illustrates a MAC CE structure for a UE operation in which a PUCCH resource power control parameter for each TRP is configured with an RRC control message and an update is applied through a MAC CE, when PUCCH repetition transmission in FR1 is configured through multiple TRPs according to another embodiment of the present disclosure.

An embodiment described herein relates to the embodiment 2 described in FIG. 9 in which the power control parameter is configured and activated for PUCCH transmission applied to PUCCH repetition transmission through the mTRP in FR1. In a method of the embodiment 2, the structure in which the PUCCH power control is performed in association with a beam in FR2 by default is directly used in FR1. The structure in which the PUCCH power control interworking with the beam in FR2, and the RRC configuration and the MAC CE structure have been described with reference to FIG. 6 and FIG. 7. It is additionally required in the embodiment 2 to describe a new constraint condition for a parameter which does not have to be applied to FR1 in the RRC configuration parameter, and it is redefined such that a UE does not perform an operation for the parameter.

That is, this is a method in which only a power control parameter part is applied by excluding beam-related information in a part interworking with the power control parameter in the existing spatial relation (beam information). Since the same RRC IE is used, it is an operation of the FR1, and when an additional indicator for excluding corresponding beam information is received from a gNB or when the UE identifies that it is the operation of the FR1 through an operating frequency, a method of applying only a power control parameter is also possible by excluding beam information without additional signaling.

The RRC configuration is applied to the embodiment 2 as follows, by referring again to the content described with reference to FIG. 6 and FIG. 7:
PUCCH resource sets: As a unit by which PUCCH resources having the same payload are aggregated, PUCCH resources existing in one PUCCH resource set have the same payload size. Up to 4 PUCCH resource sets may be configured for each BWP;
PUCCH resources: Configuration information for an actual PUCCH resource is included, and up to 32 PUCCH resources may be configured for each PUCCH resource set. The PUCCH resources use 128 indices in total; and
Spatial relations info: It indicates beam information used to transmit PUCCH resources in practice, and one beam may be selected from among SSB, CSI-RS, and SRS. Up to 8 pieces of beam information may be configured for each BWP. In Rel-16, the number of corresponding beams is increased from 8 to 64.

TABLE 4
Spatial relationship information.

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS- |

ResourceId,

| | |
|---|---|
| srs | PUCCH-SRS |
| | } |

},

| | |
|---|---|
| pucch-PathlossReferenceRS-Id | PUCCH-PathlossReferenceRS- |

Id,

| | |
|---|---|
| p0-PUCCH-Id | P0-PUCCH-Id, |
| closedLoopIndex | ENUMERATED { i0, i1 } |

}

| | |
|---|---|
| PUCCH-SpatialRelationInfoExt-r16 ::= | SEQUENCE { |
| pucch-SpatialRelationInfoId-v1610 | PUCCH- |

SpatialRelationInfoId-v1610 OPTIONAL, -- Cond SetupOnly

| | |
|---|---|
| pucch-PathlossReferenceRS-Id-v1610 | PUCCH- |

PathlossReferenceRS-Id-v1610 OPTIONAL, --Need R
...
}

| | |
|---|---|
| PUCCH-SRS ::= | SEQUENCE { |
| resource | SRS-ResourceId, |
| uplinkBWP | BWP-Id |

}

| | |
|---|---|
| PUCCH-SpatialRelationInfoId ::= | INTEGER |

(1..maxNrofSpatialRelationInfos)

| | |
|---|---|
| PUCCH-SpatialRelationInfoId-r16 ::= | INTEGER |

(1..maxNrofSpatialRelationInfos-r16)

| | |
|---|---|
| PUCCH-SpatialRelationInfoId-v1610::= | INTEGER |

maxNrofSpatialRelationInfos-plus-1..maxNrofSpatialRelationInfos-r16)

When the UE receives a parameter, an operation of ignoring the parameter may be added, and from a perspective of the gNB, how to configure the parameter may be specified. The gNB may deliver the parameter by setting the parameter to a predetermined default value (including a cell-based SSB index) or to any value. In addition, when the PUCCH repetition transmission is configured in FR1, the content regarding which value will be applied as an initial value for each TRP may be added. An initial value of power control parameters applied in initial PUCCH transmission may be an index of beam configuration parameters configured with RRC, and may be configured using at least one of the following embodiments.

In one embodiment, for an initial parameter configuration, a value applied to TRP1 and TRP2 in a to-be-configured PUCCH spatial relation info list as a parameter to be associated with a first index and a second index (a first item of the to-be-configured PUCCH transmit power parameter list may be a PUCCH transmit power parameter to be applied to TRP1 is defined and a second item may be a PUCCH transmission parameter to be applied to TRP2).

In one embodiment, an initial parameter configuration, an index for the PUCCH transmit power parameter to be applied to TRP1 and TRP2 (indicated as pucch-SpatialRelationInfoId) is explicitly configured.

In one embodiment, an initial parameter configuration, the PUCCH transmit power parameter to be applied to TRP1 and TRP2 as the same value (e.g., apply a power control parameter included in a first pucch-SpatialRelationInfoId index) is defined.

In case of the MAC CE, the same structure is also directly applied, and an operation method is also directly applicable. This is because pucch-SpatialRelationInfoId is configured in practice in the RRC configuration but only a power control parameter of PUCCH transmission remains as a parameter associated thereto:
Reserved bit (included for byte alignment; 1205, 1220, 1230, 1235, 1245, 1255, 1260, 1270, 1295, 12100, 12120, 12125);
Serving cell ID (5 bits; 1210, 1275);
BWP ID (2 bits; 1215, 1280);
TRP ID (1 bit; 1285, 12115): It may be unnecessary when a PUCCH resource ID is used by distinguishing TRP, and it is applied as a reserved bit in this case;
PUCCH resource ID (7 bits; 1225, 1250, 1290, 12115); and
Spatial relation index (6 bits; used to distinguish 64 beam identifiers, 1240, 1265, 1290, 12115).

The aforementioned MAC CE may indicate a specific beam through which a PUCCH resource in a serving cell and BWP is to be delivered. However, in the embodiment 2, only a power control parameter is associated on an RRC configuration for a corresponding spatial relation index. Therefore, the gNB reuses the same MAC CE applied in FR2 in association with a power parameter in FR1.

FIG. 13 illustrates a MAC CE structure for a UE operation in which a PUCCH resource power control parameter for each TRP is configured with an RRC control message and an update is applied through a MAC CE, when PUCCH repetition transmission in FR1 is configured through multiple TRPs according to another embodiment of the present disclosure.

An embodiment described herein relates to the embodiment 3 described in FIG. 9 in which the power control parameter is configured and activated for PUCCH transmission applied to PUCCH repetition transmission through the mTRP in FR1. In a method of the embodiment 3, a new RRC IE part for the PUCCH transmit power parameter in the embodiment 1 is slightly changed, and the legacy MAC CE applied in the FR2 as in the embodiment 2 is reused with the update of the PUCCH power control parameter for each TRP.

First, in a method in which FR1-dedicated PUCCH power control parameters in the mTRP are configured through the RRC configuration, the parameters may be configured as follows:
Power control identifier (pucch-SpatialRelationInfoId-r17) for PUCCH resource in the mTRP: A value representing the following actual parameters, as an identifier for distinguishing sets of PUCCH power control parameters. For example, 64 identifiers may be configured, and other values are also possible. Although parameter names are spatially related in practice, the names are unified to reuse the legacy MAC CE structure, and information related to spatial relation does not exist in an operation performed in practice;
PUCCH pathloss reference RS identifier (pucch-PathlossReferenceRS-Id-r17): An identifier indicating a pathloss reference RS to be referred in PUCCH transmission;
A P0 value for PUCCH (UE transmit power, p0-PUCCH-Id-r17); and
Closed loop identifier (closedLoopEndex-r17) to be applied to PUCCH transmit power control.

A structure of the aforementioned RRC parameter and new RRC IE may be expressed by ASN.1 as shown below.

TABLE 5
Power control information

| | |
|---|---|
| PUCCH-PowerControlFR1-r17 ::= | SEQUENCE { |
| pucch-SpatialRelationInfoId-r17 | PUCCH-SpatialRelationInfoId-r16, |
| pucch-PathlossReferenceRS-Id-r17 | PUCCH-PathlossReferenceRS-Id-r17, |
| p0-PUCCH-Id-r17 | P0-PUCCH-Id, |
| closedLoopIndex-r17 | ENUMERATED { i0, i1 } |

}

| | |
|---|---|
| PUCCH-SpatialRelationInfoId ::= | INTEGER (1..maxNrofSpatialRelationInfos) |
| PUCCH-SpatialRelationInfoId-r16 ::= | INTEGER (1..maxNrofSpatialRelationInfos-r16) |
| PUCCH-SpatialRelationInfoId-v1610::= | INTEGER maxNrofSpatialRelationInfos-plus- |

1..maxNrofSpatialRelationInfos-r16)

| | |
|---|---|
| PUCCH-PathlossReferenceRS-Id-r17 | ::= INTEGER (0.. maxNrofPUCCH- |

PathlossReferenceRSs-1-r16)

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |

The initial PUCCH power control parameter values applied to the TRP1 and the TRP2 may be specific values, and may be configured using at least one of the following embodiments.

In one embodiment, for an initial parameter configuration, a value applied to TRP1 and TRP2 in a to-be-configured PUCCH transmit power parameter list (pucch-SpatialRelationInfoId-r17) is defined as a parameter to be associated with a first index and a second index (a first entry of the to-be-configured PUCCH transmit power parameter list may be a PUCCH transmit power parameter of TRP1, and a second entry may be a PUCCH transmission parameter of TRP2).

In one embodiment, for an initial parameter configuration, an index for the PUCCH transmit power parameter to be applied to TRP1 and TRP2 is explicitly configured.

In one embodiment, for an initial parameter configuration, the PUCCH transmit power parameter to be applied to TRP1 and TRP2 as the same value (e.g., apply a power control parameter included in a to-be-configured first PUCCH transmission parameter index) is defined.

In case of the MAC CE, the legacy MAC CE structure used in the FR2 is directly applied, and an operation method is also directly applicable. In the RRC configuration, pucch-SpatialRelationInfoId is used as an identifier in the PUCCH-PowerControlFR1-r17 IE. Therefore, a power control parameter of PUCCH transmission may be applied as a parameter configured in practice:
Reserved bit (included for byte alignment; 1305, 1320, 1330, 1335, 1345, 1355, 1360, 1370, 1395, 13100, 13120, 13125);
Serving cell ID (5 bits; 1310, 1375);
BWP ID (2 bits; 1315, 1380);
TRP ID (1 bit; 1385, 13115): It may be unnecessary when a PUCCH resource ID is used by distinguishing TRP, and it is applied as a reserved bit in this case.
PUCCH resource ID (7 bits; 1325, 1350, 1390, 13115); and
Spatial relation index (6 bits; used to distinguish 64 beam identifiers, 1340, 1365, 1390, 13115).

The aforementioned MAC CE may indicate a specific beam through which a PUCCH resource in a serving cell and BWP is to be delivered. However, in the embodiment 3, only a power control parameter is associated on an RRC configuration for a corresponding spatial relation index. Therefore, the gNB reuses the same MAC CE applied in FR2 in association with a power parameter in FR1.

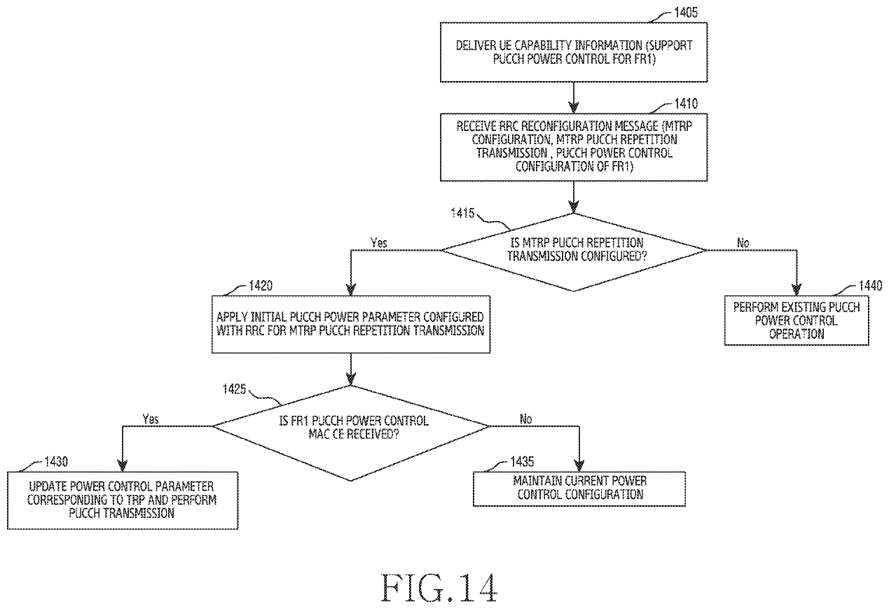

FIG. 14 illustrates an operation of a UE according to an embodiment of the present disclosure.

In step 1405, The UE in an RRC_CONNECTED state generates and contains UE capability information and deliver it to a gNB in response to a UE capability request message of the gNB. In particular, in step 1405, information on whether it is possible to perform PUCCH repetition transmission through the mTRP is included in the UE capability information. In addition, a UE supporting the UE capability information may implicitly support whether multiple serving cells simultaneously update a PUCCH resource power parameter (or UE capability information supporting this may be additionally delivered). As a method of indicating this, the following two embodiments are provided.

In one embodiment, for a UE capability delivery,

a 1-bit indicator is introduced to indicate whether a UE is capable of performing PUCCH repetition transmission through the mTRP. If it is indicated that the UE supports a corresponding capability, a gNB may configure a corresponding function.

In one embodiment, for another UE capability delivery,

an indicator indicating whether PUCCH repetition transmission is possible through the mTRP for each specific band or band configuration supported by a UE is indicated and indicated. A gNB may configure a corresponding function only for a BC in which the indicator is included.

When a corresponding indicator is indicated as TRUE for the aforementioned UE capability delivery methods, the UE may apply a corresponding capability equally to all BWPs belonging to a component carrier of the BC or a UE in which a corresponding function is configured, or a UE capability reporting that the capability is supported for each BWP may be added.

In step 1410, the gNB delivers a cell group configuration (CellGroupConfig) and configuration information (ServingCellConfig) for configuring multiple serving cells and BWPs to the UE. The RRC message includes configuration information (PDCCH-Config, PDSCH-Config) for reception through a PDCCH and a PDSCH, and a beam conformation for PUCCH resource transmission is also included in the PUCCH-Config. Specifically, the RRC message may include a BWP configuration (BWP-Uplink, BWP-Downlink), a CORESET configuration, a scrambling configuration, a TCI state configuration (TCI-State in PDSCH-Config), a PUCCH resource, a PUCCH resource set, a spatial relation info, or the like.

In particular, the TCI state-related configuration is provided for each serving cell and downlink BWP, and is included in each of PDCCH-Config and PDSCH-Config. A PUCCH resource configuration and a beam configuration for PUCCH resource transmission are also included in PUCCH-Config. A PUCCH resource, a PUCCH resource set, a spatial relation info, or the like may be configured in the PUCCH configuration, and the configuration has been described in detail with reference to FIG. 6 and FIG. 7. Multiple TRPs may be configured in step 1410, and the RRC message may include a configuration for PUCCH repetition transmission through the multiple TRPs. At the same time, when the UE is instructed to operate in the FR1 band (when a frequency band of a serving cell is the FR1 band and related configuration information is provided with RRC), in step 1410, a configuration for power control parameters for PUCCH transmission applied to PUCCH repetition transmission through the mTRP in the FR1 may be provided together. The configuration may be configured through a separate RRC information element (IE), or may be applied by reusing and redefining the legacy RRC IE. Details thereof refer to the embodiments 1, 2, and 3 (FIG. 10, FIG. 11, FIG. 12, and FIG. 13).

If it is determined in step 1415 that the UE is instructed to configure the PUCCH repetition transmission through the mTRP described above in step 1410 and if an operating frequency of a corresponding serving cell is FR1, in step 1420, the UE applies power control parameters for PUCCH transmission to each TRP. A method of applying a corresponding parameter to PUCCH transmit power transmission of each TRP may be one of the following embodiments.

In one embodiment, for an initial parameter configuration, a value applied to TRP1 and TRP2 in a to-be-configured PUCCH transmit power parameter list (PUCCH-PowerControlFR1-r17) is defined as a parameter to be associated with a first index and a second index (a first item of the to-be-configured PUCCH transmit power parameter list may be a PUCCH transmit power parameter to be applied to TRP1, and a second item may be a PUCCH transmission parameter to be applied to TRP2).

In one embodiment, for an initial parameter configuration, an index for the PUCCH transmit power parameter to be applied to TRP1 and TRP2 is explicitly configured.

In one embodiment, for an initial parameter configuration, the PUCCH transmit power parameter to be applied to TRP1 and TRP2 as the same value (e.g., apply a power control parameter included in an index of a to-be-configured first PUCCH transmission parameter) is defined.

In step 1425, the UE may receive a MAC CE which dynamically updates a parameter for PUCCH transmit power when PUCCH repetition transmission is performed through the mTRP from the gNB. When the MAC CE is received, in step 1430, the UE updates PUCCH power control parameters provided from the received MAC CE, and applies them to a power value when performing PUCCH transmission to each TRP. Thereafter, the UE may receive again the MAC CE from the gNB, and in this case, may perform PUCCH transmission by updating and applying the PUCCH transmit power parameter according to a configuration received again. The UE which does not receive the MAC CE in step 1425 proceeds to step 1435 and maintains the power parameter for the PUCCH transmission applied to the RRC configuration of the gNB in step 1420.

When the gNB does not configure the PUCCH repetition transmission for the mTRP to the UE in step 1415, the UE performs PUCCH transmission to the gNB by applying one PUCCH transmission and the legacy PUCCH power control method in step 1440.

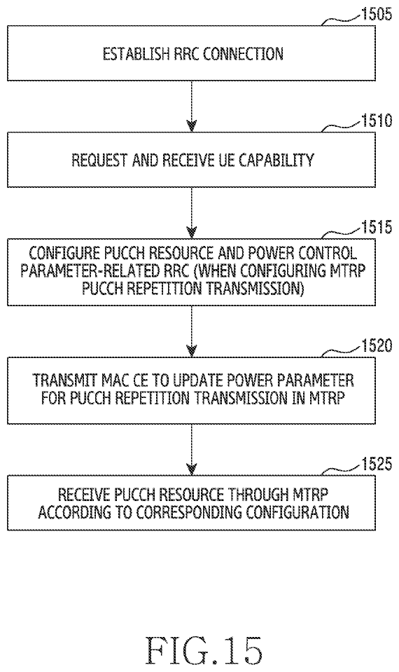

FIG. 15 illustrates an operation of a gNB according to an embodiment of the present disclosure.

The gNB may establish an RRC_CONNECTED state with respect to a UE in step 1505, and may receive UE capability information by requesting the UE for a UE capability in step 1510. The gNB may analyze the received UE capability to determine whether the UE is capable of performing PUCCH repetition transmission through the mTRP. If the corresponding capability of the UE is identified, the gNB may optionally configure PUCCH repetition transmission through the mTRP to the UE. In step 1515, the gNB configures PUCCH repetition transmission through the mTRP according to the UE capability through an RRC message to the UE.

In this case, if an operating frequency band in a corresponding serving cell is an FR1 band, the gNB may configure PUCCH transmit power parameters as follows when PUCCH repetition transmission is performed through the mTRP in FR1. This corresponds to a case of the mentioned embodiments in the present disclosure, and additional information is not provided in case of the mentioned embodiment. A correlation between the predetermined exiting RRC configuration (spatial relation ID) and the PUCCH power parameter in FR1 is applied to the embodiment 2.

In addition, the gNB may configure a simultaneous PUCCH transmit power parameter update for a PUCCH resource of multiple serving cells to a corresponding UE, which is possible by designating a serving cell group supporting a corresponding function in CellGroupConfig. If the UE does not have a corresponding capability or if the gNB determines that a corresponding configuration is not necessary, configuration information necessary for the simultaneous power parameter update operation for the multiple PUCCH resources may not be provided to support only an operation for an individual serving cell and PUCCH resource.

In step 1520, the gNB instructs a power parameter update for the multiple serving cells and PUCCH resources, based on a PUCCH resource configuration configured with RRC and related power parameter configuration information. The method described in the aforementioned embodiments may be applied to the MAC CE used in step 1520. Thereafter, in step 1525, the gNB receives a PUCCH resource through the mTRP according to a configuration and the indicated power parameter, and performs data communication.

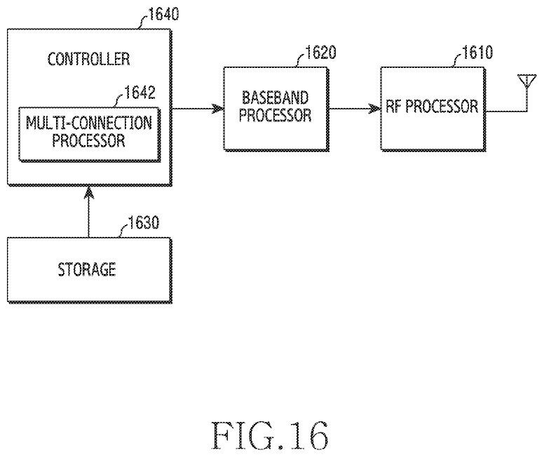

FIG. 16 is a block diagram illustrating a structure of a UE according to an embodiment of the present disclosure.

Referring to FIG. 16, the UE may include a Radio Frequency (RF) processor 1610, a baseband processor 1620, a storage 1630, and a controller 1640.

The RF processor 1610 may perform a function for transmitting and receiving a signal via a radio channel, such as signal band conversion, amplification, or the like. That is, the RF processor 1610 up-converts a baseband signal into an RF signal provided from the baseband processor 1620 and then transmits the RF signal through an antenna, and down-converts an RF signal received through the antenna into a baseband signal. For example, the RF processor 1610 may include a transmission filter, a reception filter, an amplifier, a mixer, an oscillator, a digital to analog convertor (DAC), an analog to digital Convertor (ADC), or the like. Although only one antenna is illustrated in FIG. 16, a UE may have a plurality of antennas.

In addition, the RF processor 1610 may include a plurality of RF chains. Further, the RF processor 1610 may perform beamforming. For the beamforming, the RF processor 1610 may adjust a phase and magnitude of each of signals transmitted and received through a plurality of antennas or antenna elements. In addition, the RF processor 1610 may perform a MIMO operation, and may receive several layers when performing the MIMO operation.

The baseband processor 1620 may perform a conversion function between a baseband signal and a bit-stream according to a physical layer protocol of the system. For example, in data transmission, the baseband processor 1620 may generate complex symbols by coding and modulating a transmission bit-stream. In addition, in data reception, the baseband processor 1620 may restore a reception bit-stream by demodulating and decoding a baseband signal provided from the RF processor 1610.

For example, in case of conforming to an OFDM scheme, in data transmission, the baseband processor 1620 may generate complex symbols by performing coding and modulation on a transmitted bit-stream, map the complex symbols to subcarriers, and then configure OFDM symbols by performing an inverse fast Fourier transform (IFFT) operation and a cyclic prefix (CP) insertion operation. In addition, in data reception, the baseband processor 1620 may split the baseband signal provided from the RF processor 1610 on an OFDM symbol basis, restore signals mapped to the subcarriers by using a FFT operation, and then restore a received bit-stream by performing demodulation and decoding.

The baseband processor 1620 and the RF processor 1610 transmit and receive a signal as described above. Accordingly, the baseband processor 1620 and the RF processor 1610 may be referred to as a transmitter, a receiver, a transceiver, or a communication circuit. Further, at least one of the baseband processor 1620 and the RF processor 1610 may include a plurality of communication modules to support a plurality of different radio access technologies. In addition, at least one of the baseband processor 1620 and the RF processor 1610 may include different communication modules to process signals of different frequency bands. For example, the different radio access technologies may include an LTE network, an NR network, or the like. In addition, the different frequency bands may include a super high frequency (SHF)(e.g., 2.5 GHz, 5 GHz) band and a millimeter (mm) wave (e.g., 60 GHz) band. The UE may transmit and receive a signal with respect to the gNB by using the baseband processor 1620 and the RF processor 1610. Herein, the signal may include control information and data.

The storage 1630 may store data such as a basic program, an application program, setup information, or the like for an operation of the UE. The storage 1630 may provide stored data at the request of the controller 1640.

The controller 1640 may control overall operations of the UE. For example, the controller 1640 transmits and receives a signal via the baseband processor 1620 and the RF processor 1610. In addition, the controller 1640 writes data to the storage 1630 and reads the data. For this, the controller 1640 may include at least one processor. For example, the controller 1640 may include a communication processor (CP) which provides control for communication and an Application Processor (AP) which provides control to a higher layer such as an application program.

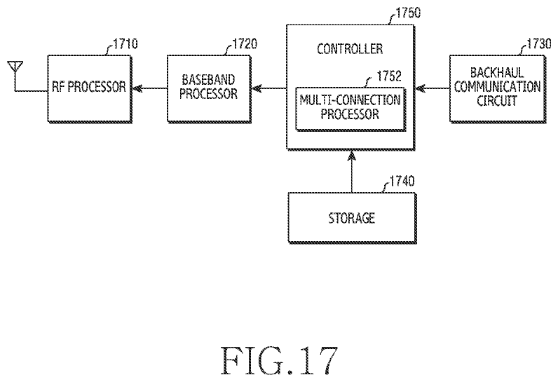

FIG. 17 illustrates a structure of a gNB according to an embodiment of the present disclosure.

According to an embodiment, the gNB may include a TRP. Referring to FIG. 17, the gNB may include an RF processor 1710, a baseband processor 1720, a backhaul communication circuit 1730, a storage 1740, and a controller 1750.

The RF processor 1710 performs a function for transmitting and receiving a signal via a radio channel, such as signal band conversion, amplification, or the like. That is, the RF processor 1710 may up-convert a baseband signal into an RF signal provided from the baseband processor 1720 and then transmit the RF signal through an antenna, and may down-convert an RF signal received through the antenna into a baseband signal. For example, the RF processor 1710 may include a transmission filter, a reception filter, an amplifier, a mixer, an oscillator, a DAC, an ADC, or the like. Although only one antenna is illustrated in FIG. 17, a UE may have a plurality of antennas. In addition, the RF processor 1710 may include a plurality of RF chains. Further, the RF processor 1710 may perform beamforming. For the beamforming, the RF processor 1710 may adjust a phase and magnitude of each of signals transmitted and received through a plurality of antennas or antenna elements. The RF processor may perform a downlink MIMO operation by transmitting at least one layer.

The baseband processor 1720 may perform a conversion function between a baseband signal and a bit-stream according to a physical layer protocol of a radio access technology. For example, in data transmission, the baseband processor 1720 may generate complex symbols by coding and modulating a transmission bit-stream. In addition, in data reception, the baseband processor 1720 may restore a reception bit-stream by demodulating and decoding a baseband signal provided from the RF processor 1710.

For example, in case of conforming to an OFDM scheme, in data transmission, the baseband processor 1720 may generate complex symbols by performing coding and modulation on a transmitted bit-stream, map the complex symbols to subcarriers, and then configure OFDM symbols by performing an IFFT operation and a CP insertion operation. In addition, in data reception, the baseband processor 1720 may split the baseband signal provided from the RF processor 1710 on an OFDM symbol basis, restore signals mapped to the subcarriers by using an FFT operation, and then restore a received bit-stream by performing demodulation and decoding. The baseband processor 1720 and the RF processor 1710 transmit and receive a signal as described above. Accordingly, the baseband processor 1720 and the RF processor 1710 may be referred to as a transmitter, a receiver, a transceiver, or a communication circuit. The gNB may transmit and receive a signal with respect to the UE by using the baseband processor 1720 and the RF processor 1710.

The backhaul communication circuit 1730 provides an interface for performing communication with other nodes in the network. That is, the backhaul communication circuit 1730 may convert a bitstream transmitted from a main gNB to another node, i.e., an auxiliary gNBs, a core network, or the like, into a physical signal, and may convert the physical signal received from another node into a bitstream.

The storage 1740 may store data such as a basic program, an application program, setup information, or the like for an operation of the main gNB. In particular, the storage 1740 may store information on a bearer assigned to an accessed UE, a measurement result reported from the accessed UE, or the like. In addition, the storage 1740 may store information used as a criterion for determining whether to provide or stop multi-connectivity to the UE. In addition, the storage 1740 may provide the stored data at the request of the controller 1750.

The controller 1750 controls overall operations of the main gNB. For example, the controller 1750 transmits and receives a signal via the baseband processor 1720 and the RF processor 1710 or via the backhaul communication circuit 1730. In addition, the controller 1750 writes data to the storage 1740 and reads the data. For this, the controller 1750 may include at least one processor.

In various embodiments, a method performed by a user equipment (UE) in a wireless communication system, the method comprising: receiving, from a base station, a radio resource control (RRC) message including information on at least one power control set for a repetition of a physical uplink control channel (PUCCH) transmission based on a single beam configuration, and information on one or more PUCCH resources, receiving, from the base station, a medium access control control element (MAC CE) indicating identifier (ID) of the one or more PUCCH resources associated with an ID of the at least one power control set, and updating the information on the at least one power control set corresponding to at least one transmission reception point (TRP), based on the received MAC CE.

In one embodiment, wherein the information on the at least one power control set included in the RRC configuration message includes at least one of an ID of a reference signal for estimating a PUCCH path loss, a value of transmission power (P0) of the UE, or an index of a closed loop for a power control of the PUCCH transmission.

In one embodiment, wherein the RRC configuration message further includes information on a PUCCH resource group, wherein the method further comprises, in case that the PUCCH resource group includes the ID of the one or more PUCCH resource indicated by the MAC CE, updating the information on the at least one power control set associated with all of PUCCH resources in the PUCCH resource group, based on the received MAC CE, and wherein the at least one power control set corresponds to the at least one TRP.

In one embodiment, wherein the method further comprising: transmitting, to the base station, UE capability information indicating whether the UE supports the repetition of the PUCCH transmission via the at least one TRP based on the single beam configuration.

In various embodiments, a method performed by abase station in a wireless communication system, the method comprising: transmitting, to a user equipment (UE), a radio resource control (RRC) message including information on at least one power control set for a repetition of a physical uplink control channel (PUCCH) transmission based on a single beam configuration, and information on one or more PUCCH resources, and transmitting, to the UE, a medium access control control element (MAC CE) indicating identifier (ID) of the one or more PUCCH resources associated with an ID of the at least one power control set, wherein the information on the at least one power control set corresponding to at least one transmission reception point (TRP) is updated based on the transmitted MAC CE.

In one embodiment, wherein the information on the at least one power control set included in the RRC configuration message includes at least one of an ID of a reference signal for estimating a PUCCH path loss, a value of transmission power (P0) of the UE, or an index of a closed loop for a power control of the PUCCH transmission.

In one embodiment, wherein the RRC configuration message further includes information on a PUCCH resource group, wherein, in case that the PUCCH resource group includes the ID of the one or more PUCCH resource indicated by the MAC CE, the information on the at least one power control set associated with all of PUCCH resources in the PUCCH resource group is updated based on the transmitted MAC CE, and wherein the at least one power control set corresponds to the at least one TRP.

In one embodiment, wherein the method further comprising: receiving, from the UE, UE capability information indicating whether the UE supports the repetition of the PUCCH transmission via the at least one TRP based on the single beam configuration.

In various embodiments, a user equipment (UE) in a wireless communication system, the UE comprising, at least one transceiver, and at least one processor operably coupled to the at least one transceiver, wherein the at least one processor is configured to: receive, from a base station, a radio resource control (RRC) message including information on at least one power control set for a repetition of a physical uplink control channel (PUCCH) transmission based on a single beam configuration, and information on one or more PUCCH resources, receive, from the base station, a medium access control control element (MAC CE) indicating identifier (ID) of the one or more PUCCH resources associated with an ID of the at least one power control set, and update the information on the at least one power control set corresponding to at least one transmission reception point (TRP), based on the received MAC CE.

In one embodiment, wherein the information on the at least one power control set included in the RRC configuration message includes at least one of an ID of a reference signal for estimating a PUCCH path loss, a value of transmission power (P0) of the UE, or an index of a closed loop for a power control of the PUCCH transmission.

In one embodiment, wherein the RRC configuration message further includes information on a PUCCH resource group, wherein the at least one processor is further configured to: in case that the PUCCH resource group includes the ID of the one or more PUCCH resource indicated by the MAC CE, update the information on the at least one power control set associated with all of PUCCH resources in the PUCCH resource group, based on the received MAC CE, and wherein the at least one power control set corresponds to the at least one TRP.

In one embodiment, wherein the at least one processor is further configured to: transmit, to the base station, UE capability information indicating whether the UE supports the repetition of the PUCCH transmission via the at least one TRP based on the single beam configuration.

In various embodiments, abase station in a wireless communication system, the base station comprising: at least one transceiver, and at least one processor operably coupled to the at least one transceiver, wherein the at least one processor is configured to: transmit, to a user equipment (UE), a radio resource control (RRC) message including information on at least one power control set for a repetition of a physical uplink control channel (PUCCH) transmission based on a single beam configuration, and information on one or more PUCCH resources, and transmit, to the UE, a medium access control control element (MAC CE) indicating identifier (ID) of the one or more PUCCH resources associated with an ID of the at least one power control set, wherein the information on the at least one power control set corresponding to at least one transmission reception point (TRP) is updated based on the transmitted MAC CE.

In one embodiment, wherein the information on the at least one power control set included in the RRC configuration message includes at least one of an ID of a reference signal for estimating a PUCCH path loss, a value of transmission power (P0) of the UE, or an index of a closed loop for a power control of the PUCCH transmission.

In one embodiment, wherein the RRC configuration message further includes information on a PUCCH resource group, wherein, in case that the PUCCH resource group includes the ID of the one or more PUCCH resource indicated by the MAC CE, the information on the at least one power control set associated with all of PUCCH resources in the PUCCH resource group is updated based on the transmitted MAC CE, and wherein the at least one power control set corresponds to the at least one TRP.

Methods based on the embodiments disclosed in the claims and/or specification of the disclosure may be implemented in hardware, software, or a combination of both.

When implemented in software, computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

The program (i.e., the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment provided herein. However, the singular or plural expression is selected properly for a situation provided for the convenience of explanation, and thus the various embodiments of the disclosure are not limited to a single or a plurality of components. Therefore, a component expressed in a plural form may also be expressed in a singular form, or vice versa.

On the other hand, embodiments of the disclosure disclosed in the specification and drawings are presented only as a specific example for clarity and are not intended to limit the scope of the disclosure. That is, it is apparent to those ordinarily skilled in the art to which the disclosure pertains that other modifications based on the technical idea of the disclosure are possible. In addition, each of the embodiments may be operated optionally in combination with each other. For example, an embodiment of the disclosure and some parts of other embodiments may be combined together to operate a gNB and a UE. In addition, other modifications based on the technical idea of the aforementioned embodiment may be implemented in various systems such as an FDD LTE system, a TDD LTE system, a 5G or NR system, or the like.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, a radio resource control (RRC) message including information on one or more power control sets for a repetition of a physical uplink control channel (PUCCH) transmission in a frequency band and information on one or more PUCCH resources;
receiving, from the base station, a medium access control control element (MAC CE) indicating an identifier (ID) of a PUCCH resource among the one or more PUCCH resources, wherein the ID of the PUCCH resource is associated with at least one first power control set among the one or more power control sets; and
updating, based on the received MAC CE, the at least one first power control set associated with the ID of the PUCCH resource,
wherein the at least one first power control set corresponds to at least one transmission reception point (TRP).

2. The method of claim 1, wherein the information on the one or more power control sets included in the RRC configuration message includes at least one of an ID of a reference signal for estimating a PUCCH path loss, a value of transmission power (P0) of the UE, or an index of a closed loop for a power control of the PUCCH transmission.

3. The method of claim 1, further comprising:
in case that a PUCCH resource group includes one or more IDs of the PUCCH resource indicated by the MAC CE, updating, based on the received MAC CE, at least one second power control set among the one or more power control sets,
wherein the at least one second power control set is associated with all of PUCCH resources in the PUCCH resource group,
wherein the RRC configuration message further includes information on the PUCCH resource group, and
wherein the at least one second power control set corresponds to the at least one TRP.

4. The method of claim 1, further comprising:
transmitting, to the base station, UE capability information indicating whether the UE supports the repetition of the PUCCH transmission via the at least one TRP in the frequency band.

5. A method performed by a base station in a wireless communication system, the method comprising:
transmitting, to a user equipment (UE), a radio resource control (RRC) message including information on one or more power control sets for a repetition of a physical uplink control channel (PUCCH) transmission in a frequency band and information on one or more PUCCH resources; and
transmitting, to the UE, a medium access control control element (MAC CE) indicating an identifier (ID) of a PUCCH resource among the one or more PUCCH resources, wherein the ID of the PUCCH resource is associated with at least one first power control set among the one or more power control sets,
wherein the at least one first power control set associated with the ID of the PUCCH resource is updated based on the transmitted MAC CE, and
wherein the at least one first power control set corresponds to at least one transmission reception point (TRP).

6. The method of claim 5, wherein the information on the one or more power control sets included in the RRC configuration message includes at least one of an ID of a reference signal for estimating a PUCCH path loss, a value of transmission power (P0) of the UE, or an index of a closed loop for a power control of the PUCCH transmission.

7. The method of claim 5, wherein the RRC configuration message further includes information on a PUCCH resource group,
wherein, in case that the PUCCH resource group includes one or more IDs of the PUCCH resource indicated by the MAC CE, at least one second power control set among the one or more power control sets is updated based on the transmitted MAC CE,
wherein the at least one second power control set is associated with all of PUCCH resources in the PUCCH resource group, and
wherein the at least one second power control set corresponds to the at least one TRP.

8. The method of claim 5, further comprising:
receiving, from the UE, UE capability information indicating whether the UE supports the repetition of the PUCCH transmission via the at least one TRP in the frequency band.

9. A user equipment (UE) in a wireless communication system, the UE comprising:
at least one transceiver; and
at least one processor operably coupled to the at least one transceiver, wherein the at least one processor is configured to:
receive, from a base station, a radio resource control (RRC) message including information on one or more power control sets for a repetition of a physical uplink control channel (PUCCH) transmission in a frequency band and information on one or more PUCCH resources,
receive, from the base station, a medium access control control element (MAC CE) indicating identifier (ID) of a PUCCH resource among the one or more PUCCH resources, wherein the ID of the PUCCH resource is associated with at least one first power control set among the one or more power control sets, and
update, based on the received MAC CE, the at least one first power control set associated with the ID of the PUCCH resource,
wherein the at least one first power control set corresponds to at least one transmission reception point (TRP).

10. The UE of claim 9, wherein the information on the one or more power control sets included in the RRC configuration message includes at least one of an ID of a reference signal for estimating a PUCCH path loss, a value of transmission power (P0) of the UE, or an index of a closed loop for a power control of the PUCCH transmission.

11. The UE of claim 9, wherein the RRC configuration message further includes information on a PUCCH resource group,
wherein the at least one processor is further configured to, in case that the PUCCH resource group includes one or more ID of the PUCCH resource indicated by the MAC CE, update, based on the received MAC CE, at least one second power control set among the one or more power control sets,
wherein the at least one second power control set is associated with all of PUCCH resources in the PUCCH resource group, and
wherein the at least one second power control set corresponds to the at least one TRP.

12. The UE of claim 9, wherein the at least one processor is further configured to:
transmit, to the base station, UE capability information indicating whether the UE supports the repetition of the PUCCH transmission via the at least one TRP in the frequency band.

13. A base station in a wireless communication system, the base station comprising:
at least one transceiver; and
at least one processor operably coupled to the at least one transceiver, wherein the at least one processor is configured to:
transmit, to a user equipment (UE), a radio resource control (RRC) message including information on one or more power control sets for a repetition of a physical uplink control channel (PUCCH) transmission in a frequency band and information on one or more PUCCH resources, and
transmit, to the UE, a medium access control control element (MAC CE) indicating an identifier (ID) of a PUCCH resource among the one or more PUCCH resources, wherein the ID of the PUCCH resource is associated with at least one first power control set among the one or more power control sets,
wherein the at least one first power control set associated with the ID of the PUCCH resource is updated based on the transmitted MAC CE, and
wherein the at least one first power control set corresponds to at least one transmission reception point (TRP).

14. The base station of claim 13, wherein the information on the one or more power control sets included in the RRC configuration message includes at least one of an ID of a reference signal for estimating a PUCCH path loss, a value of transmission power (P0) of the UE, or an index of a closed loop for a power control of the PUCCH transmission.

15. The base station of claim 13, wherein the RRC configuration message further includes information on a PUCCH resource group,
wherein, in case that the PUCCH resource group includes one or more IDs of the PUCCH resource indicated by the MAC CE, at least one second power control set among the one or more power control sets is updated based on the transmitted MAC CE,
wherein the at least one second power control set is associated with all of PUCCH resources in the PUCCH resource group, and
wherein the at least one second power control set corresponds to the at least one TRP.

16. The base station of claim 13, wherein the at least one processor is further configured to receive from, the UE, UE capability information indicating whether the UE supports the repetition of the PUCCH transmission via the at least one TRP in the frequency band.
